(19) United States
(12) Patent Application Publication
(10) Pub. No.: US 2021/0097426 A1
(43) Pub. Date: Apr. 1, 2021

(54) INFORMATION PROCESSING APPARATUS, INFORMATION PROCESSING METHOD, AND STORAGE MEDIUM

(71) Applicant: LINK AND MOTIVATION INC., Tokyo (JP)

(72) Inventors: Yoshihisa OZASA, Tokyo (JP); Hideki SAKASHITA, Tokyo (JP)

(21) Appl. No.: 16/585,160

(22) Filed: Sep. 27, 2019

(51) Int. Cl. G06N 20/00; G06F 16/23; G06F 40/30

(52) U.S. Cl. CPC G06N 20/00; G06F 40/30; G06F 16/2379

(57) ABSTRACT

An information processing apparatus includes: an organization response information storage unit in which pieces of organization response information each indicating a response to a question to an organization member are stored in association with organization identifiers each for identifying an organization; a learning information storage unit in which learning information acquired using pieces of positive example information regarding one or more improvement items or one or more plans in a case in which each of the organizations is improved is stored; an accepting unit that accepts acceptance information containing organization response information indicating a response to a question to an organization member; a proposal information acquiring unit that acquires proposal information, which is information corresponding to the acceptance information and is information regarding one or more improvement items or one or more plans, using the learning information; and an output unit that outputs the proposal information.

### BACKGROUND OF THE INVENTION

### 1. Field of the Invention

The present invention relates to an information processing apparatus and the like for making proposals for improving organizations according to questionnaire results of organization members.

### 2. Description of Related Art

Conventionally, there is an organization improvement activity assisting system for making findings obtained through a wide variety of organization activities, available for many organizations (see JP 2017-59111A, for example).

This organization improvement activity assisting system includes: a plan information storage part in which, for each plan, a theme matching degree indicating the degree of an effect of the plan for each predetermined stress item, and an organization matching degree in which the suitability of the plan to each content that an organization property which is an especially specified organization property may have is quantified as the degree of an influence that is given to the theme matching degree, are stored; a plan proposing part that proposes a plan to an organization based on the information stored in the plan information storage part; an activity log storage part in which two or more activity reports indicating the activity content of an organization that actually performed an activity are stored as activity logs; an activity log analyzing part that determines, for a certain plan, whether or not there is inconsistency in a relationship between the organization property and the effect or a relationship between the theme and the effect indicated by the information stored in the plan information storage part, based on the activity logs stored in the activity log storage part; and a user cooperation part that, in case in which it is determined that there is the inconsistency, gives notice to a predetermined user.

However, according to conventional techniques, it is not possible to make a proper proposal for improving an organization, using organization response information, which is information regarding responses to a questionnaire to organization members.

### SUMMARY OF THE INVENTION

A first aspect of the present invention is directed to an information processing apparatus including: an organization response information storage unit in which two or more pieces of organization response information each indicating a response to a question to an organization member are stored in association with organization identifiers each for identifying an organization; a learning information storage unit in which learning information acquired using two or more pieces of positive example information regarding one or more improvement items or one or more plans in a case in which each of the two or more organizations is improved is stored; an accepting unit that accepts acceptance information containing organization response information indicating a response to a question to an organization member; a proposal information acquiring unit that acquires proposal information, which is information corresponding to the acceptance information and is information regarding one or more improvement items or one or more plans, using the learning information; and an output unit that outputs the proposal information.

With this configuration, it is possible to make a proper proposal for improving an organization, using the organization response information, Furthermore, a second aspect of the present invention is directed to the information processing apparatus according to the first aspect, wherein the positive example information contains one or more organization attribute values, each of which is an attribute value of an organization, the accepting unit accepts acceptance information having organization response information and one or more organization attribute values, and the proposal information acquiring unit acquires proposal information, which is information corresponding to the acceptance information having the organization response information and the one or more organization attribute values accepted by the accepting unit and is information regarding one or more improvement items or one or more plans, using the learning information.

With this configuration, it is possible to make a more proper proposal for improving an organization, according to the organization attribute value, using the organization response information.

Furthermore, a third aspect of the present invention is directed to the information processing apparatus according to the second aspect, wherein, in the learning information storage unit, two or more pieces of learning information associated with one or more organization attribute values are stored, and the proposal information acquiring unit acquires proposal information, using learning information corresponding to the one or more organization attribute values contained in the acceptance information.

With this configuration, it is possible to make a more proper proposal for improving an organization, according to the organization attribute value, using the organization response information.

Furthermore, a fourth aspect of the present invention is directed to the information processing apparatus according to any one of the first to third aspects, wherein the organization response information contains a natural language sentence, the positive example information also contains an analysis result acquired by analyzing the natural language sentence contained in the organization response information, and the proposal information acquiring unit includes: an analysis part that analyzes the natural language sentence contained in the organization response information accepted by the accepting unit, thereby acquiring an analysis result; an application information acquiring part that acquires application information that is applied to learning information, using information that is contained in the organization response information and is other than the natural language sentence, and the analysis result; and a proposal information acquiring part that applies the application information to the learning information, thereby acquiring proposal information.

With this configuration, it is possible to make a more proper proposal for improving an organization, also using a natural language sentence described by a member.

Furthermore, a fifth aspect of the present invention is directed to the information processing apparatus according to any one of the first to fourth aspects, wherein score change information regarding a change in a score of an organization is stored in association with the positive example information, and the proposal information acquiring unit acquires proposal information, which is information corresponding to the acceptance information and is information regarding one or more improvement items or one or more plans, also using the score change information.

With this configuration, it is possible to make a more proper proposal for improving an organization, using the organization response information. and the score change information of the organization.

Furthermore, a sixth aspect of the present invention is directed to the information processing apparatus according to any one of the first to fifth aspects, wherein the learning information is a learning device trained through an algorithm of machine learning, using organization response information and positive example information, and the proposal information acquiring unit includes: an application information acquiring part that acquires application information that is a vector, using the acceptance information accepted by the accepting unit; and a proposal information acquiring part that applies the application information to the learning information, thereby acquiring proposal information through an algorithm of machine learning.

With this configuration, it is possible to make a proper proposal for improving an organization, using the organization response information.

Furthermore, a seventh aspect of the present invention is directed to the information processing apparatus according to any one of the first to fifth aspects, wherein the learning information is a correspondence table containing two or more pieces of correspondence information having a vector configured using organization response information and one or more pieces of positive example information in association with each other, and the proposal information acquiring unit includes: an application information acquiring part that acquires application information that is a vector, using the acceptance information accepted by the accepting unit; and a proposal information acquiring part that acquires one or more pieces of proposal information paired with a vector satisfying a condition that is predetermined for the application information, from the correspondence table.

With this configuration, it is possible to make a proper proposal for improving an organization, using the organization response information.

With the information processing apparatus according to the present invention, it is possible to make a proper proposal for improving an organization, using the organization response information.

### BRIEF DESCRIPTION OF THE DRAWINGS

FIG. 1 is a conceptual diagram of an information system A in Embodiment 1.

FIG. 2 is a block diagram of the information system A in the embodiment.

FIG. 3 is a flowchart illustrating an operation example of an information processing apparatus 1 in the embodiment.

FIG. 4 is a flowchart illustrating an example of first learning processing in the embodiment.

FIG. 5 is a flowchart illustrating an example of score calculating processing in the embodiment.

FIG. 6 is a flowchart illustrating an example of second learning processing in the embodiment.

FIG. 7 is a flowchart illustrating an example of application information acquiring processing in the embodiment.

FIG. 8 is a flowchart illustrating an example of first proposal information acquiring processing in the embodiment.

FIG. 9 is a flowchart illustrating an example of second proposal information acquiring processing in the embodiment.

FIG. 10 shows an example of an item information management table in the embodiment.

FIG. 11 shows an example of an organization response information of an organization in the embodiment.

FIG. 12 shows an example of an individual score table in the embodiment.

FIG. 13 shows an organization information management table in the embodiment.

FIG. 14 shows an output example in the embodiment.

FIG. 15 shows an example of a correspondence table in the embodiment.

FIG. 16 is a schematic view of a computer system in the embodiment.

FIG. 17 is a block diagram of the computer system in the embodiment.

### DETAILED DESCRIPTION OF THE INVENTION

Hereinafter, an embodiment of an information processing apparatus and the like will be described with reference to the drawings. It should be noted that constituent elements denoted by the same reference numerals in the embodiments perform similar operations, and thus a description thereof may not be repeated.

### Embodiment 1

In this embodiment, an information system will be described including an information processing apparatus in which two or more pieces of positive example information using a member's questionnaire result to two or more questions and one or more pieces of plan etc. information in a case in which an organization has been improved are stored, wherein the apparatus accepts a member's questionnaire result to two or more questions, and acquires and outputs proposal information having one or more pieces of plan etc. information. The plan etc. information is information regarding an improvement item or a plan.

Furthermore, in this embodiment, an information system will be described including an information processing apparatus that acquires and outputs proposal information also considering an attribute value of an organization.

Furthermore, in this embodiment, an information system will be described including an information processing apparatus that acquires and outputs proposal information also using a natural language sentence input to a free entry section of a questionnaire.

Moreover, in this embodiment, an information system will be described including an information processing apparatus that acquires and outputs proposal information for improving a score of an organization, using information regarding a change in the score.

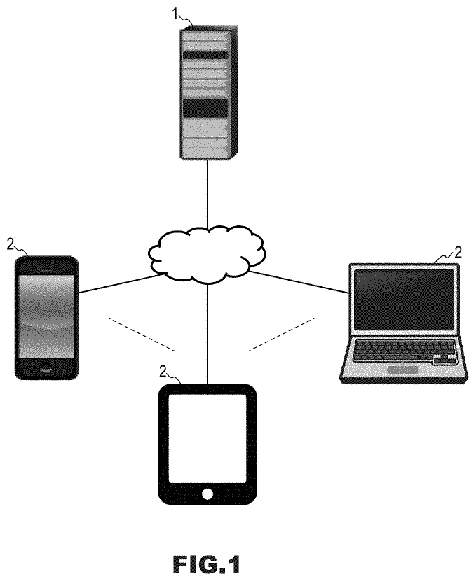

FIG. 1 is a conceptual diagram of an information system A in this embodiment. The information system A includes an information processing apparatus 1 and one or at least two terminal apparatuses 2. The information processing apparatus 1 in this example is a so-called server apparatus. The information processing apparatus 1 is, for example, a cloud server or an ASP server, and there is no limitation on the type or installation location thereof. Each terminal apparatus 2 is a mobile terminal such as a smartphone, a tablet device, or a mobile phone, a so-called personal computer, or the like, and there is no limitation on the type thereof. The terminal apparatus 2 may be a terminal that is used by an administrator of the information system, or may be a terminal that is used by a general user.

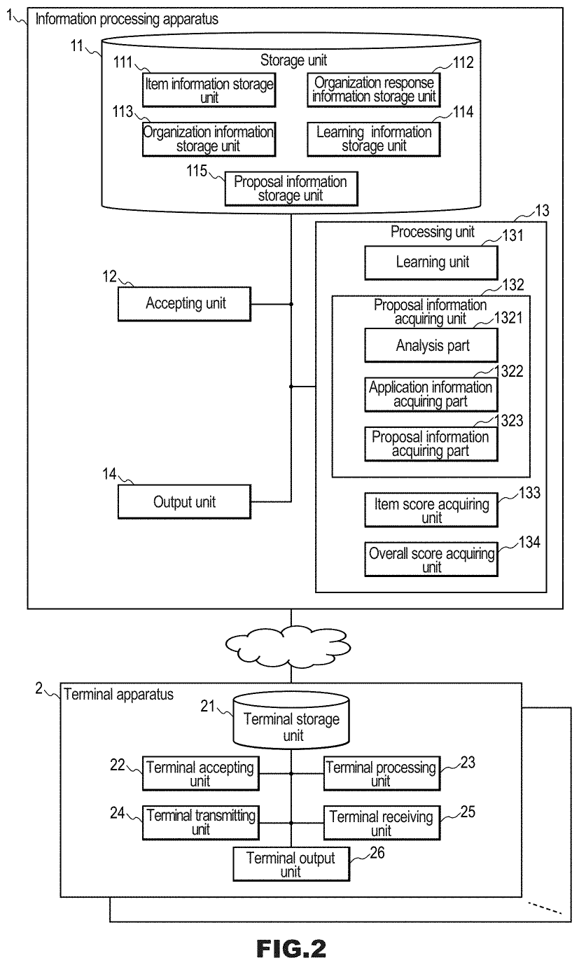

FIG. 2 is a block diagram of the information system A. in this embodiment.

The information processing apparatus 1 constituting the information system A includes a storage unit 11, an accepting unit 12, a processing unit 13, and an output unit 14.

The storage unit 11 includes an item information storage unit 111, an organization response information storage unit 112, an organization information storage unit 113, a learning information storage unit 114, and a proposal information storage unit 115.

The processing unit 13 includes a learning unit 131, a proposal information acquiring unit 132, an item score acquiring unit 133, and an overall score acquiring unit 134.

The proposal information acquiring unit 132 includes an analysis part 1321, an application information acquiring part 1322, and a proposal information acquiring part 1323.

The terminal apparatus 2 includes a terminal storage unit 21, a terminal accepting unit 22, a terminal processing unit 23, a terminal transmitting unit 24, a terminal receiving unit 25, and a terminal output unit 26.

In the storage unit 11 constituting the information processing apparatus 1, various types of information are stored. The various types of information are, for example, later-described organization response information, later-described organization information, later-described learning information, and later-described proposal information.

The various types of information are, for example, an individual score table. The individual score table may also be said to be an engagement score table or the like. The individual score table in this example is, information in which, if satisfaction level information and expectation level information are given, an item score is decided on. The individual score table in this example is, for example, a table having an axis of satisfaction level information and an axis of expectation level information, wherein table cells respectively show individual scores, so that, if satisfaction level information and expectation level information are decided on, an item score is decided on. This individual score table is preferably a table in which the larger the satisfaction level indicated by the satisfaction level information is, the larger the acquired item score is, and the smaller the expectation level indicated by the expectation level information is, the larger the acquired item score is.

It is also possible to decide on an item score, using an operation expression having, as parameters, satisfaction level information and expectation level information. This operation expression is preferably, for example, an increasing function having, as a parameter, satisfaction level information. Alternatively; this operation expression is, for example, a decreasing function having, as a parameter, expectation level information.

Furthermore, it is also possible to learn multiple sets of satisfaction level information, expectation level information, and an item score through machine learning, and to decide on an item score using the acquired learning information. In this case, satisfaction level information and expectation level information are applied to learning information, and an item score is acquired through. machine learning. As the machine learning in this example, for example, SVR, deep learning, decision trees, random forests, and the like are available. Note that there is no limitation on the algorithm of the machine learning.

Alternatively the various types of information are, for example, one or at least two organization attribute value sets. An organization attribute value set is a group of one or at least two organization attribute values. If learning information is configured for each organization attribute value set, the organization attribute value set is information that is stored in the storage unit 11. The organization attribute value set is, for example, “an industry type 1”, “an industry type 2” . . . , or “an industry type n”. The organization attribute value set is, for example, “human resources department, 20s”, “human resources department, 30 and older”, “accounting department, 20s”, or “accounting department, 30 and older”.

In the item information storage unit 111, two or more pieces of item information are stored. The item information is information regarding an item of an organization. The item may be a question regarding an organization. The item may be associated with a question regarding an organization. The two or more items include, for example, an overall item regarding an overall matter of an organization, and an individual item, which is an individual item of the organization. The overall item is typically an item for a question with a high abstraction degree. The individual item is typically an item for a question with a lower abstraction degree (a more specific question). The two or more pieces of item information in the item information storage unit 111 have, for example, item information of four overall items and item information of 64 individual items. Each item. corresponds to, for example, any one of the two or more objects. An object may also be said to be a factor. The object may also be said to be a matter regarding an organization. The item information has, for example, an item identifier for identifying an item, and question information. The item identifier is, for example, an ID, an item name, or the like. The item identifier may be question information itself. The question information is information indicating a question. The question is typically a question in a questionnaire. The matter may also be said to be an object or an item.

In the organization response information storage unit 112, organization response information of two or more organizations is stored. The organization response information is information indicating a response to a question to an organization member. The question may also be said to be a topic or an item. The question is typically a question constituting a questionnaire.

Furthermore, the organization response information stored in the organization response information storage unit 112 is organization response information based on a questionnaire before a certain plan is implemented, and is organization response information in an organization improved after the plan is implemented.

The organization response information is preferably associated with positive example information. The positive example information is information regarding an improvement item or plan that was implemented in an improved organization. The positive example information is, for example, information regarding one or more improvement items or one or more plans in the case in which each of the two or more organizations has been improved. The positive example information is information acquired using the organization response information, and the information regarding one or more improvement items or one or more plans.

The positive example information may be improvement item identifying information for identifying an improvement item, or plan identifying information for identifying a plan. The improvement item identifying information is, for example, a name of an improvement item, information indicating the content of an improvement item, or an ID of an improvement item. The plan identifying information is, for example, a name of a plan, information indicating the content of a plan, or an ID of a plan. The improvement item is, for example, “fulfillment level of IT environment”, “fulfilment level of training system”, or “validity of salary”. The plan is, for example, “make attempt to increase speed of IT network”, “regularly perform in-house training”, “increase salary to industry-wide standard”, or “introduce side-job system”.

The positive example information may be information containing the organization response information, and the information regarding one or more improvement items or one or more plans. The positive example information may also contain one or more organization attribute values. It is preferable that the positive example information also contains an analysis result acquired by analyzing a natural language sentence contained in the organization response information. The positive example information may be information acquired also using score change information regarding a change between scores before and after an improvement or a plan is implemented. The score change information is information regarding a change between a score before an improvement of an organization and a score after the improvement. The score change information is, for example, a difference between an overall score before an improvement of an organization and an overall score after the improvement (an increase in the overall score). The score change information is, for example, a value calculated using a function that is a decreasing function having, as a parameter, an overall score before an improvement of an organization, and that is an increasing function having, as a parameter, an overall score after the improvement.

Furthermore, the organization response information is typically associated with an organization identifier for identifying an organization. The organization identifier is an organization name, an ID for identifying an organization, or the like. The organization response information is, for example, associated with an organization attribute value, which is one or more attribute values of an organization. The organization attribute value is, for example, an industry type identifier indicating an industry type of an organization (e.g., bank, apparel, manufacturer, etc.), a size identifier for classifying a size of an organization (e.g., large enterprise, small-to-medium sized enterprise, micro enterprise, self-employed, etc.), information indicating a category of an organization based on business conditions of an organization (e.g., in the black, in the red, etc.), a region identifier indicating the region of a home office, a sector identifier for identifying a sector in an organization (e.g., human-resources, accounting, laboratory, engineering division, sales division, manufacturing division, etc.), a listing identifier indicating whether or not an organization is listed, a stage identifier indicating a stage of an organization (e.g., founding period, expansion period, diversification period, revitalization period, etc.), a business model identifier indicating a business model (e.g., innovator business that performs multiple types of businesses, professional business that performs a small number of businesses such as one business and depends on people, operator business that performs a small number of businesses such as one business and depends on systems, etc.), or the like. The industry type may be rough classification such as financing company; manufacturer, trading company, service industry; or the like, or fine classification such as bank, securities company, electronics manufacturer, food manufacturer, machine manufacturer, or the like. it will be appreciated that there is no limitation on how to classify industry types and the like.

One piece of organization response information is a group of information on responses from two or more members of one organization. One piece of organization response information has two or more pieces of member response information respectively corresponding to two or more members. The member response information is information containing a response of a member to a question for an item. The member response information has two or more pieces of item response information. The number of pieces of item response information contained in the member response information is typically the same as the number of items. The item response information has an item identifier and response information. The response information is information regarding a response to a question. The response information has, for example, satisfaction level information. The satisfaction level information is information indicating a response regarding a satisfaction level of a member to an item. The satisfaction level information is, for example, information for specifying a satisfaction level to an item. The satisfaction level information is classified into two or more classes. The satisfaction level information may take, for example, any natural number of 1 to 5. Note that the satisfaction level information may be, for example, an evaluation value, such as A, B, and C, having the rank or order, or may be any natural number of 1 to 100, for example. The response information has, for example, satisfaction level information and expectation level information. The expectation level information is information indicating a response regarding an expectation level of a member to an item. The expectation level information is, for example, information for specifying an expectation level to an item. The expectation level information is classified into two or more classes. The expectation level information may take, for example, any natural number of 1 to 5. Note that the expectation level information is, for example, an evaluation value, such as A, B, and C, having the rank or order, or may be any natural number of 1 to 100, for example. There is no limitation on the content of an item, a question, and the like. The member is, for example, an employee of a company a staff member of a school, a staff member of a government office, or the like, but may also include an executive of a company and the like. The member may be a non-regular worker.

The overall item is, for example, a company satisfaction level indicating a level of being satisfied with a company a job satisfaction level indicating a level of being satisfied with a job, a supervisor satisfaction level indicating a level of being satisfied with a supervisor, a workplace satisfaction level indicating a level of being satisfied with a workplace, or the like. The individual item is, for example, a business superiority of a company transmission and transfer of a strategic objective, a sense of overall solidarity, validity of evaluation and salary, or the like.

In the organization information storage unit 113, two or more pieces of organization information are stored. The organization information is information regarding an organization. The organization information has an organization identifier and one or more organization attribute values. The organization information may have an organization identifier, an organization attribute value, and an overall score, which is an overall score of an organization. The overall score in this example may be an absolute overall score that does not depend on an organization attribute value.

In the learning information storage unit 114, learning information is stored. The learning information is information acquired using the two or more pieces of positive example information. The learning information is, for example, information acquired using multiple pairs of the organization. response information and the positive example information stored in the organization response information storage unit 112.

In the learning information storage unit 114, two or more pieces of learning information associated with one or more organization attribute values may be stored.

The learning information may be information acquired also using one or at least two pieces of negative example information. The negative example information is information regarding an improvement item or a plan in the case in which an organization has not been improved. The negative example information is, for example, organization response information, and information regarding an improvement item or plan that was implemented in an organization in which a questionnaire resulted in the organization response information was implemented, but provided no improvement.

The learning information is, for example, a learning device built through an algorithm of machine learning. The learning information is, for example, a learning device acquired by a later-described learning unit 131. As the machine learning in this example, for example, SVR, SVM, deep learning, decision trees, random forests, and the like are available. Note that there is no limitation on the algorithm of the machine learning.

The learning information is, for example, a correspondence table. The learning information is, for example, a correspondence table acquired by a later-described learning unit 131. The correspondence table has two or more pieces of correspondence information. The correspondence information is information (which may also be said to be proposal information) having a vector configured using organization response information, and plan etc. information, which is information regarding one or more improvement items or one or more plans. The vector in this example may be a vector configured using organization response information, and one or more types of information among one or more organization attribute values and an analysis result acquired by analyzing a natural language sentence, instead of using only the organization response information. The proposal information is, for example, one or more pieces of improvement item identifying information or one or more pieces of plan identifying information.

In the proposal information storage unit 115, one or more pieces of proposal information are stored. Each of the one or more pieces of proposal information stored in the proposal information storage unit 115 is information that may be proposed. The proposal information is typically associated with a proposal identifier. The proposal identifier is information for identifying proposal information, and is, for example, an ID, improvement item identifying information, or plan identifying information. The proposal information is, for example, information regarding a plan that an organization has to implement, or information illustrating an item that an organization has to improve.

The accepting unit 12 accepts the various types of information or instructions. The various types of information or instructions are, for example, acceptance information. The acceptance information is information for specifying an object for which an improvement item, a plan, or the like of an organization is proposed. The acceptance information contains organization response information indicating a response to a question to an organization member. The acceptance information preferably has organization response information and one or more organization attribute values. It is preferable that, the organization response information contains a natural language sentence. The natural language sentence is, for example, a sentence described in a free entry section of a questionnaire. The sentence may be part of information constituting the sentence (e.g., a group of one or at least two words). The organization response information and the one or more organization attribute values contained in the acceptance information accepted by the accepting unit 12 may be accepted by different parts. For example, it is possible that the organization response information is received together with an organization identifier, and one or more organization attribute values paired with the organization identifier are read from the organization information storage unit 113.

The various types of information or instructions are, for example, a learning instruction. The learning instruction is an instruction to configure learning information.

The accepting is, for example, receiving information transmitted via a wired or wireless communication line, and accepting information read from a storage medium such as an optical disk, a magnetic disk, or a semiconductor memory but is a concept that also encompasses accepting information input from an input device such as a keyboard, a mouse, or a touch panel. It is preferable that this concept is broadly interpreted. The receiving is typically receiving from the terminal apparatus 2.

The processing unit 13 performs various types of processing. The various types of processing are, for example, the processes that are performed by the learning unit 131, the proposal information acquiring unit 132, the item score acquiring unit 133, the overall score acquiring unit 134, and the like.

The learning unit 131 acquires learning information, using the two or more pieces of positive example information, and accumulates it in the learning information storage unit 114. in this example, the learning information is, for example, a learning device or a correspondence table. Hereinafter, examples of the case in which the learning unit 131 acquires a learning device and the case in which the learning unit 131 acquires a correspondence table will be described.

(1) Case in which the Learning Unit 131 Acquires Learning Device

The learning unit 131 learns, for example, two or more pieces of learning object information having organization response information of an organization before an improvement, and positive example information regarding one or more improvement items or one or more plans implemented for the improvement, and configures a learning device through an algorithm of machine learning. The learning object information may have one or more organization attribute values. The two or more pieces of learning object information having organization response information of an organization before an improvement and positive example information are, for example, stored in the organization response information storage unit 112.

The learning unit 131 configures a vector, for example, using organization response information of an organization before an improvement. For example, the learning unit 131 configures a vector having, as elements, item scores of two or more items acquired from the organization response information. That is to say a later-described item score acquiring unit 133 calculates item scores of items from the organization response information in the organization response information storage unit 112, and, for example, configures a vector (the item score of an item 1, the item score of an item 2, . . . , the item score of an item n). The vector is a group of elements (values), and there is no limitation on its data structure and the like. The method for calculating an item score using organization response information is similar to that in the process that is performed by a later-described item score acquiring unit 133. It is also possible that the item score acquiring unit 133 calculates an item score.

The learning unit 131 may, for example, configure a vector, using organization response information of an organization before an improvement, and one or more organization attribute values. The learning unit 131 may, for example, take item scores of two or more items acquired from the organization response information, as elements, acquire elements corresponding to the one or more organization attribute values, and configure a vector that is a group of the acquired elements. For example, the learning unit 131 configures a vector (the item score of the item 1, the item score of the item 2, . . . , the item score of the item n, whether or not one or more organization attribute values contain information indicating “the industry type 1”, whether or not one or more organization attribute values contain information indicating “the industry type 2”, . . . , whether or not one or more organization attribute values contain information indicating “the industry type n”, . . . , whether or not one or more organization attribute values contain information indicating “being listed”, . . . ).

For example, the learning unit 131 configures a vector having, as elements, score change information. In this case, the vector is, for example, (the item score of the item 1, the item score of the item 2, . . . , the item score of the item n, score change information), or (the item score of the item 1, the item score of the item 2, . . . , the item score of the item n, whether or not one or more organization attribute values contain information indicating “the industry type 1”, whether or not one or more organization attribute values contain information indicating “the industry type 2”, whether or not one or more organization attribute values contain information indicating “the industry type n”, whether or not one or more organization attribute values contain information indicating “being listed”, . . . , score change information).

For example, the learning unit 131 configures a vector also using positive example information. In this case, the vector is, for example, (the item score of the item 1, the item score of the item 2, the item score of the item n, whether or not a plan 1 has been implemented, whether or not a plan 2 has been implemented, . . . , whether or not a plan n has been implemented), (the item score of the item 1, the item score of the item 2, . . . , the item score of the item n, whether or not one or more organization attribute values contain information indicating “the industry type 1”, whether or not one or more organization attribute values contain information indicating “the industry type 2”, . . . , whether or not one or more organization attribute values contain. information indicating “the industry type n”, . . . , whether or not one or more organization attribute values contain information indicating “being listed”, whether or not the plan 1 has been implemented, whether or not the plan 2 has been implemented, whether or not the plan n has been implemented), or (the item score of the item 1, the item score of the item 2, . . . , the item score of the item n, score change information, whether or not the plan 1 has been implemented, whether or not the plan 2 has been implemented, . . . , whether or not the plan n has been implemented).

Next, the learning unit 131 learns, for example, the configured vector as a positive example through an algorithm of machine learning, thereby configuring a learning device,

Alternatively the learning unit 131 learns, for example, a vector configured without using score change information, and score change information, for example, through an algorithm of SVR machine learning, thereby configuring a learning device.

It is preferable that the learning unit 131 configures a learning device also using one or more pieces of negative example information indicating that no improvement was properly achieved. The structure of the vector configured using the negative example information is the same as that of a vector corresponding to the positive example information.

The negative example information is, for example, information regarding one or more improvement items or one or more plans with which an organization has not been improved. The negative example information is associated with, for example, organization response information of an organization before an improvement. The negative example information may have organization response information of an organization before an improvement. For example, the learning unit 131 configures one or more vectors, from one or more pieces of organization response information corresponding to the negative example information. These vectors are vectors corresponding to the negative example information. Then, the learning unit 131 learns, for example, the vectors corresponding to the positive example information and the vectors corresponding to the negative example information through an algorithm of machine learning, thereby configuring a learning device.

It is also possible that the learning unit 131 learns, for example, a vector corresponding to a negative example configured without using score change information, and score change information, for example, through an algorithm of SVR, machine learning, thereby configuring a learning device.

(2) Case in which the Learning Unit 131 Acquires Correspondence Table

The learning unit 131 configures a vector, for example, using organization response information stored in association with positive example information. This organization response information is organization response information of an organization before an improvement. Next, the learning unit 131 configures correspondence information having, as pairs, a vector and positive example information paired with the organization response information from which the vector was configured.

The learning unit 131 performs this correspondence information configuring processing the same number of times as the number of pieces of organization response information stored in association with positive example information, thereby configuring a correspondence table having two or more pieces of correspondence information.

The proposal information acquiring unit 132 acquires proposal information, which is information corresponding to the acceptance information and is information regarding one or more improvement items or one or more plans, using the learning information.

The proposal information acquiring unit 132 acquires, for example, proposal information, which is information corresponding to the acceptance information having the organization response information and the one or more organization attribute values accepted by the accepting unit 12 and is information regarding one or more improvement items or one or more plans, using the learning information.

The proposal information acquiring unit 132 acquires, for example, proposal information, using learning information corresponding to the one or more organization attribute values contained in the acceptance information.

The proposal information acquiring unit 132 acquires, for example, proposal information, which is information corresponding to the acceptance information and is information regarding one or more improvement items or one or more plans, also using the score change information.

The proposal information in this example is, for example, information for specifying one or more improvement items or information for specifying one or more plans. The proposal information that may be output is, for example, stored in the proposal information storage unit 115.

Hereinafter, the process of the proposal information acquiring unit 132 performed in two cases consisting of the case in which the learning information is a learning device and the case in which the learning information is a correspondence table will be described.

(1) Process of Proposal Information Acquiring Unit 132 in Case in which Learning Information is Learning Device
(1-1) Case without using Score Change Information, in which there is No Learning Device for Each Organization Attribute Value

The proposal information acquiring unit 132 configures a vector, using the organization response information contained in the acceptance information accepted by the accepting unit 12, or the organization response information and the one or more organization attribute values contained in the acceptance information accepted by the accepting unit 12. The vector configuring process is similar to the vector configuring process that is performed by the learning unit 131, and thus a detailed description thereof has been omitted.

Next, the proposal information acquiring unit 132 configures a vector from a combination of “to implement/not, to implement” each of the one or more pieces of proposal information in the proposal information storage unit 115. That is to say for example, if proposal information for specifying one or more plans is stored in the proposal information storage unit 115, the proposal information acquiring unit 132 configures vectors having, as elements, information for identifying “to implement i not to implement” the plans, the number of vectors being the same as that of the combinations. That is to say for example, if proposal information for specifying three plans (plan A, plan B, plan C) is stored in the proposal information storage unit 115, the proposal information acquiring unit 132 configures vectors “to implement not to implement” the plans (plan A, plan B, plan C), that is, “seven patterns of vectors (1, 0, 0), (0, 1, 0), (0, 0, 1), (1, 1, 0), (1, 0, 1), (0, 1, 1), (1, 1, 1)”,

Next, the proposal information acquiring unit 132 configures a vector by compositing the vector acquired using the organization response information or the organization response information and the one or more organization attribute values, and the vector acquired using the proposal. information.

That is to say the proposal information acquiring unit 132 acquires, for example, the following composite vector. That is to say the composite vector is, for example, (the item score of the item 1, the item score of the item 2, . . . , the item score of the item n, whether or not to implement the plan 1, whether or not to implement the plan 2, whether or not to implement the plan n), (the item score of the item 1, the item score of the item 2, . . . , the item score of the item n, whether or not one or more organization attribute values contain information indicating “the industry type 1”, whether or not one or more organization attribute values contain information indicating “the industry type 2”, . . . , whether or riot one or more organization attribute values contain information indicating “the industry type n”, . . . , whether or not one or more organization attribute values contain information indicating “being listed”, whether or not to implement the plan 1, whether or not to implement the plan 2, whether or not to implement the plan n), or (the item score of the item 1, the item score of the item 2, . . . , the item score of the item n, score change information, whether or not to implement, the plan 1, whether or not to implement the plan 2, whether or not to implement the plan n). The composite vector is the application information.

Next, the proposal information acquiring unit 132 applies the composite vector to the learning device of the learning information storage unit 114, thereby acquiring an application result through an algorithm of machine learning. The application result is, for example, information indicating the positive example (an improvement is achieved through implementation of the plan) or the negative example (an improvement is not achieved through implementation of the plan). For example, if proposal information for specifying three plans (plan A, plan B, plan C) is stored in the proposal information storage unit 115, the proposal information acquiring unit 132 applies the seven composite vectors to the learning device, and judges whether each of the seven composite vectors is a positive example or a negative example. The algorithm of the machine learning in this example is an algorithm of machine learning for solving a binary sorting problem, and examples thereof include SVM, deep learning, decision trees, and the like.

Then, the proposal information acquiring unit 132 acquires proposal information, which is a combination of one or more plans with which an improvement can be expected, from a composite vector corresponding to a positive example. For example, if proposal information for specifying three plans (plan A plan B, plan C) is stored in the proposal information storage unit 115 and it is judged that a composite vector containing the vector “(1, 0, 0), (1, 0, 1), (1, 1, 1)” acquired from the proposal information is a positive example, the proposal information acquiring unit 132 acquires three pieces of proposal information “plan A”, “plan A, plan C”, and “plan A, plan B, plan C”.

(1-2) Case without using Score Change Information, in which there is Learning Device for Each Organization Attribute Value

The proposal information acquiring unit 132 configures one or at least two composite vectors (application information), using the organization response information contained in the acceptance information accepted by the accepting unit 12, or the organization response information and the one or more organization attribute values contained in the acceptance information accepted by the accepting unit 12, as described in (1-1).

Next, the proposal information acquiring unit 132 selects a learning device corresponding to the one or more organization attribute values contained in the acceptance information accepted by the accepting unit 12, from the learning information storage unit 114.

Next, the proposal information acquiring unit 132 applies the one or more composite vectors to the selected learning device, and judges whether each vector is a positive example or a negative example.

Then, the proposal information acquiring unit 132 acquires proposal information, which is a combination of one or more plans with which an improvement can be expected, from a composite vector corresponding to a positive example.

(1-3) Case using Score Change Information, in which there is No Learning Device for Each Organization Attribute Value

The proposal information acquiring unit 132 configures one or at least two composite vectors, using the organization response information or the organization response information and the one or more organization attribute values, and the proposal information, as described above.

Next, the proposal information acquiring unit 132 applies each of the one or more composite vectors to the learning device of the learning information storage unit 114, thereby acquiring an application result through an algorithm of machine learning. The application result in this example is a score. The algorithm of the machine learning in this example is an algorithm of machine learning for acquiring scores, and examples thereof include SVR. The score is, for example, the score change information.

Then, if the acquired score is greater than or equal to a threshold or is greater than the threshold, the proposal information acquiring unit 132 acquires, as proposal information, information of a plan acquired from a vector that is contained in a composite vector corresponding to the score and that is acquired from the proposal information.

For example, if proposal information for specifying three plans (plan A, plan B, plan C) is stored in the proposal information storage unit 115, and it is judged that the score acquired using the composite vector containing the vector “(1, 0, 0), (1, 0, 1), (1, 1, 1)” acquired from the proposal information is greater than or equal to a threshold or is greater than the threshold, the proposal information acquiring unit 132 acquires three pieces of proposal information “plan A”, “plan A, plan C”, and “plan A, plan B, plan C”.

(1-4) Case using Score Change Information, in which there is Learning Device for Each Organization Attribute Value

The proposal information acquiring unit 132 configures one or at least two composite vectors, using the organization response information or the organization response information and the one or more organization attribute values, and the proposal information, as described above.

Next, the proposal information acquiring unit 132 selects a learning device corresponding to the one or more organization attribute values, from the learning information storage unit 114.

Next, the proposal information acquiring unit 132 applies the one or more composite vectors to the selected learning device, thereby acquiring a score through an algorithm of machine learning.

Then, if the acquired score is greater than or equal to a threshold or is greater than the threshold, the proposal information acquiring unit 132 acquires, as proposal information, information of a plan acquired from a vector that is contained in a composite vector corresponding to the score and that is acquired from the proposal information.

(2) Process of Proposal Information Acquiring Unit 132 in Case in which Learning Information is Correspondence Table
(2-1) Case without using Score Change Information, in which there is No Correspondence Table for Each Organization Attribute Value

The proposal information acquiring unit 132 configures a vector, using the organization response information contained in the acceptance information accepted by the accepting unit 12, or the organization response information and the one or more organization attribute values contained in the acceptance information accepted by the accepting unit 12.

Next, the proposal information acquiring unit 132 acquires one or at least two pieces of proposal information paired with a vector satisfying a condition that is predetermined for the acquired vector, from the correspondence table. The predetermined condition is, for example, a condition in which the distance is closest, or the distance is within a threshold or is less than the threshold.

(2-2) Case without using Score Change Information, in which there is Correspondence Table for Each Organization Attribute Value

The proposal information acquiring unit 132 configures a vector, using the organization response information contained in the acceptance information accepted by the accepting unit 12, or the organization response information and the one or more organization attribute values contained in the acceptance information accepted by the accepting unit 12.

Next, the proposal information acquiring unit 132 selects a correspondence table corresponding to the one or more organization attribute values contained in the acceptance information, from the learning information storage unit 114.

Next, the proposal information acquiring unit 132 acquires one or more pieces of proposal information paired with a vector satisfying a condition that is predetermined for the acquired vector, from the selected correspondence table.

(2-3) Case without using Score Change Information, in which there is No Correspondence Table for Each Organization Attribute Value.

The proposal information acquiring unit 132 configures a vector, using the organization response information contained in the acceptance information accepted by the accepting unit 12, or the organization response information and the one or more organization attribute values contained in the acceptance information accepted by the accepting unit 12.

Next, the proposal information acquiring unit 132 acquires one or at least two pieces of proposal information paired with a vector satisfying a condition (typically, a condition regarding the distance, for example, in which the distance is within a threshold or is less than the threshold) that is predetermined for the acquired vector, the information being one or more pieces of proposal information corresponding to information in which the score change information satisfies a predetermined condition, from the correspondence table. The predetermined condition that is satisfied by the score change information is, for example, a condition in which the score change information indicates the largest improvement, or the score change information is greater than or equal to a threshold or is greater than the threshold.

(2-4) Case without using Score Change Information, in which there is Correspondence Table for Each Organization Attribute Value

The proposal information acquiring unit 132 configures a vector, using the organization response information contained in the acceptance information accepted by the accepting unit 12, or the organization response information and the one or more organization attribute values contained in the acceptance information accepted by the accepting unit 12.

Next, the proposal information acquiring unit 132 selects a correspondence table corresponding to the one or more organization attribute values contained in the acceptance information, from the learning information storage unit 114.

Next, the proposal information acquiring unit 132 acquires one or at least two pieces of proposal information paired with a vector satisfying a condition (typically, a condition regarding the distance, for example, in which the distance is within a threshold or is less than the threshold) that is predetermined for the acquired vector, the information being one or more pieces of proposal information corresponding to information in which the score change information satisfies a predetermined condition, from the selected correspondence table.

The analysis part 1321 analyzes the natural language sentence contained in the organization response information accepted by the accepting unit 12, thereby acquiring an analysis result. The analysis part 1321 performs, for example, morphological analysis on a natural language sentence contained in the organization response information, thereby acquiring an analysis result from a group of the acquired morphemes. The analysis result is, for example, the number of times that a registered term, which is a term that has been registered in advance, appears, whether or not a term that has been registered in advance appears, the number of times that two or more successive term groups that have been registered in advance appear, whether or not two or more successive term groups that have been registered in advance appear, or the like.

The analysis part 1321 acquires, for example, the number of times that a registered term, which is a term that has been registered in advance, appears, from a natural language sentence contained in the organization. response information. Then, the analysis part 1321 configures a vector having, as elements, the number of times that the registered term appears. This vector is, for example, (the number of times that a predetermined term 1 appears, the number of times that a predetermined term 2 appears, . . . , the number of times that the predetermined term n appears), (whether or not the predetermined term 1 appears, whether or not the predetermined term 2 appears, . . . , whether or not the predetermined term n appears), (the number of times that predetermined 2-gram(1) appears, the number of times that predetermined 2-gram(2) appears, . . . , the number of times that predetermined 2-gram(n) appears), or the like. It is preferable that the elements of this vector are the elements of the above-described composite vector. It is assumed that the information of the predetermined terms, predetermined 2-gram, and the like is stored in the storage unit 11.

The application information acquiring part 1322 acquires application information that is applied to learning information, using information that is contained in the organization response information and is other than the natural language sentence, and the analysis result. The application information acquiring part 1322 configures a vector, from the organization response information, the organization response information and the one or more attribute values, the organization response information and the natural language sentence, or the organization response information, the one or more attribute values, and the natural language sentence. This vector constitutes the application information. The application information may also be the above-described composite vector.

The application information acquiring part 1322 acquires application information that is a vector, using the acceptance information accepted by the accepting unit 12.

The application information that is a vector acquired by the application information acquiring part 1322 is, for example, (the item score of the item 1, the item score of the item 2, . . . , the item score of the item n, the number of times that the predetermined term 1 appears, the number of times that the predetermined term 2 appears, . . . , the number of times that the predetermined term n appears, whether or not to implement the plan 1, whether or not to implement, the plan 2, whether or not to implement the plan n), (the item score of the item 1, the item score of the item 2, . . . , the item score of the item n, the number of times that the predetermined term 1 appears, the number of times that the predetermined term 2 appears, . . . , the number of times that the predetermined term n appears, whether or not one or more organization attribute values contain information indicating “the industry type 1”, whether or not one or more organization attribute values contain information indicating “the industry type 2”, . . . , whether or not one or more organization attribute values contain information indicating “the industry type n”, . . . , whether or not one or more organization attribute values contain information indicating “being listed”, . . . , whether or not to implement the plan 1, whether or not to implement the plan 2, . . . , whether or not to implement the plan n.), or (the item score of the item 1, the item score of the item 2, . . . , the item score of the item n, the number of times that the predetermined term 1 appears, the number of times that the predetermined term 2 appears, . . . , the number of times that the predetermined term n appears, score change information, whether or not to implement the plan 1, whether or not to implement the plan 2, . . . , whether or not to implement the plan n).

The proposal information acquiring part 1323 applies the application information (composite vector) acquired by the application information acquiring part 1322 to the learning information, thereby acquiring proposal information. The process that applies the application information to the learning information, thereby acquiring proposal information has been described in detail above, and thus a description thereof will not be repeated.

The proposal information acquiring part 1323 applies the application information to the learning information, thereby acquiring proposal information through an algorithm of machine learning. Examples of this processing are shown in (1-1) to (1-4) above.

The proposal information acquiring part 1323 acquires, for example, one or more pieces of positive example information paired with a vector that is closest to the application information, from the correspondence table, and acquires proposal information using the one or more pieces of positive example information. Examples of this processing are shown in (2-1) to (2-4) above.

The item score acquiring unit 133 performs statistical processing on the satisfaction level information contained in the response information for each of the two or more items contained in the organization response information of an organization, thereby acquiring an item score for each organization and for each item. The item score acquiring unit 133 may calculate, for example, an average value (which may also be a median value or the like) of the satisfaction level information for each item, and accumulate the average value as an item score in an unshown buffer or the storage unit 11 so as to be paired with the item identifier. The item score acquiring unit 133 may, for example, acquire an item score for each item using an increasing function having, as parameters, two or more pieces of satisfaction level information, and accumulate it in an unshown buffer or the storage unit 11 so as to be paired with the item identifier. For example, the item score acquiring unit 133 may for each item, perform different weighting according to a member's attribute value, calculate a weighted average value of the satisfaction level, and accumulate the weighted average value as an item score in an unshown buffer or the storage unit 11 so as to be paired with the item identifier. The member's attribute value is, for example, the position, the length of service, the sex, or the like. For example, the item score acquiring unit 133 may calculate a weighted average value while making the weight of the satisfaction level information of a long-service employee greater than that of a short-service employee.

The item score acquiring unit 133 acquires item scores of at least some of the items, using the satisfaction level information and the expectation level information. The item for which an item score is acquired using the satisfaction level information and the expectation level information is, for example, an individual item.

It is preferable that the item score acquiring unit 133 acquires an item score, for example, such that the higher the satisfaction level information is, the higher the score is, and such that the lower the expectation level information is, the higher the score is.

The item score acquiring unit 133 calculates, for example, for each of the two or more organizations and for each of the two or more items, a statistical value (e.g., an average value or an intermediate value) of the satisfaction level information contained in the response information and a statistical value (e.g., an average value or an intermediate value) of the expectation level information contained in the response information, and acquires an item score for each item using the two statistical values.

The item score acquiring unit 133 may, for example, apply the satisfaction level information and the expectation level information to the individual score table, thereby acquiring an item score for each item. The item score acquiring unit 133 may; for example, apply a statistical processing result of the satisfaction level information and a statistical processing result of the expectation level information to the individual score table, thereby acquiring an item score for each item. The item score acquiring unit 133 may, for example, apply an average value of the satisfaction level information and an average value of the expectation level information to the individual score table, thereby acquiring an item score for each item. The item score acquiring unit 133 may, for example, apply a weighted average value of the satisfaction level information and a weighted average value of the expectation level information to the individual score table, thereby acquiring an item score for each item. The weighted average value is a weighted average value based on a member's attribute value.

The item score acquiring unit 133 may, for example, calculate an item score for each item, using a function that is an increasing function having, as a parameter, a statistical value (e.g., an average value or a median value) of the satisfaction level information, and is a decreasing function having, as a parameter, an average value of the expectation level information.

In the description above, the process in which the item score acquiring unit 133 calculates a so-called absolute item score was described. The absolute item score is an item score that does not depend on an organization identifier such as the industry type, and is acquired typically only from response information corresponding to organization identifier of one organization.

Note that it is also possible that the item score acquiring unit 133 calculates a so-called relative item score. That is to say the item score acquiring unit 133 acquires, for example, an item score according to an organization attribute value. In this case, the item score acquiring unit 133 calculates, for example, an absolute item score of each item of the organization. Then, the item score acquiring unit 133 calculates, for example, a relative item score, using one or more item scores acquired from response information corresponding to one or more organization identifiers paired with the same organization attribute value (e.g., the same industry type) as the organization attribute value of the organization.

The item score acquiring unit 133 calculates, for example, a deviation of the absolute item score of the organization, using an item score of an organization identified with one or more organization identifiers paired with the same organization attribute value as that of the organization.

Techniques for calculating a relative item score, which is a deviation of one absolute item score, using multiple absolute item scores are well known.

Furthermore, the item score acquiring unit 133 may, for example, calculate an average value of two or more absolute item scores acquired from response information corresponding to one or more organization identifiers paired with the same organization attribute value as that of the organization, and acquire a relative item score, using a difference between the average value and the absolute item score of the organization. This relative item. score may be a difference itself between an average value of item scores and the absolute item score of the organization, or may be a value calculated by substituting this difference as a parameter for an operation expression.

That is to say there are various conceivable methods for calculating a relative item score of one organization, using absolute item scores of multiple organizations corresponding to the same organization attribute value. The same organization attribute value means that one or at least two organization attribute values are the same. The item score acquiring unit 133 may, for example, calculate a relative item score of a company of interest among multiple companies of the same industry type, or may calculate a relative item score of a company of interest among multiple companies within a category of the same industry type and with a similar size, for each item.

The overall score acquiring unit 134 acquires an overall score for two or more pieces of organization response information, using two or more item scores. The overall score is an overall score of an organization. Typically the higher each of the two or more item scores is, the higher the overall score acquired by the overall score acquiring unit 134 is.

The overall score acquiring unit 134 may acquire an attribute value-considering overall score, which is a score of an organization identified with an organization identifier, and is a score of the organization according to one or at least two organization attribute values paired with the organization identifier, using multiple pieces of organization response information.

That is to say the overall score acquiring unit 134 may for example, acquire an attribute value-considering overall score, which is a relative overall score of one organization, among multiple organizations matching the condition configured using one or at least two organization attribute values. For example, the overall score acquiring unit 134 may for example, acquire an attribute value-considering overall score of “laboratory+engineering division” of A company, which is a manufacturer, from the response information of employees belonging to a laboratory or an engineering division of a specific organization (e.g., A company), among multiple organizations with the type identifier “manufacturer” and the sector identifier “laboratory or engineering division”. In this case, the condition is “(industry type identifier=manufacturer) AND (sector identifier=laboratory OR engineering division)”. The overall score acquiring unit 134 acquires, for example, an absolute overall score, using two or more absolute item scores.

Furthermore, the overall score acquiring unit 134 acquires, for example, an attribute value-considering overall score, which is a relative overall score, using two or more relative item scores.

The overall score acquiring unit 134 preferably acquires an overall score using a score adjusting function as follows. The score adjusting function is a function of adjusting a score using correlation information regarding the degree of correlation between the satisfaction level information and the expectation level information. In this example, it is preferable to set the score adjusting function such that the higher the correlation between the satisfaction level information and the expectation level information is, the higher the overall score is.

The overall score acquiring unit 134 acquires, for example, for each organization, a tentative overall score, which is a tentative overall score of each organization, using two or more item scores, acquires correlation information regarding the degree of correlation between the satisfaction level information and the expectation level information for each of the two or more items, and acquires an overall score from the tentative overall score using the correlation information such that the higher the degree of correlation is, the higher the score is. The correlation information may be a correlation value between a group of satisfaction level information and a group of expectation level information for two or more items, a value calculated using an operation expression that is an increasing function having, as a parameter, the number of items in which a difference between satisfaction level information for each of the two or more items and expectation level information for each of the two or more items is less than or equal to a threshold, or a value calculated using an operation expression that is a decreasing function having, as a parameter, the number of items in which a difference between satisfaction level information for each of the two or more items and expectation level information for each of the two or more items is less than or equal to a threshold, and the satisfaction level information is smaller. That is to say there is no limitation on the algorithm for acquiring correlation information.

The overall score acquiring unit 134 preferably acquires an overall score, using both an overall item score of an item and an individual item score of the item. The overall score acquiring unit 134 preferably acquires an overall score, using both an overall item score of an item and an individual item score of the item while making the weight of overall item scores of items greater than that of individual item scores of the items. Also in this case, the overall score acquiring unit 134 can acquire an absolute overall score, using an absolute item score. Also, the overall score acquiring unit 134 can acquire an attribute value-considering overall score, using a relative item score.

The overall score acquiring unit 134 may, for example, calculate an overall score, using the equation “overall score=α×statistical score of overall item scores of items+β×statistical score of individual item scores of items”. In this example, it is preferable that (α>β). That is to say the overall score acquiring unit 134 preferably acquires an overall score while making the weight of overall item scores of items greater than that of individual item scores of the items. For example, “α=0.7, β=0.3”. The statistical score of overall item scores of items is, for example, an average value, a weighted average value, or the like of overall item scores of items, statistical score of individual item scores of items is, for example, an average value, a weighted average value, or the like of individual item scores of items.

Furthermore, the overall score acquiring unit 134 may for example, calculate a tentative overall score, using the equation “tentative overall score=α×statistical score of overall item scores of items+β×statistical score of individual item scores of items”, perform score adjustment using the above-described score adjusting function, and calculate an overall score. The overall score acquiring unit 134 may, for example, calculate a deviation of an overall score of each organization, using overall scores of multiple organizations, and take the deviation as a final overall score.

The overall score acquiring unit 134 acquires an overall score and an organization attribute value paired with an organization identifier, and acquires an attribute value-considering overall score, which is a score of an organization according to the organization attribute value, using the overall score and the organization attribute value. The attribute value-considering overall score may be regarded as a relative overall score that depends on an organization attribute value. Also, the attribute value-considering overall score may also be said to be a relative engagement score. The organization attribute value in this case is one or at least two organization attribute values.

The overall score acquiring unit 134 acquires, for example, an attribute value-considering overall score, which is a score of an organization identified with an organization identifier, and is a score of the organization according to an organization attribute value paired with the organization identifier, using multiple pieces of organization response information.

The overall score acquiring unit 134 acquires an overall score and an organization attribute value paired with an organization identifier, and acquires an attribute value-considering overall score., using the overall score and the organization attribute value. The overall score in this example is an absolute overall score, and the attribute value-considering overall score is a relative overall score.

The overall score acquiring unit 134 acquires an attribute value-considering overall score, using the two or more relative item scores acquired by the item score acquiring unit 133. Typically, the higher the relative item score is, the higher the attribute value-considering overall score acquired by the overall score acquiring unit 134 is. The overall score acquiring unit 134 acquires, for example, an attribute value-considering overall score, using an increasing function (e.g., an average value, a weighted average value, a sum, etc.) having, as a parameter, the two or more relative item scores acquired by the item score acquiring unit 133. For example, a correspondence table of groups of two or more relative item scores and attribute value-considering overall scores is stored in the storage unit 11, and, referring to the correspondence table, the overall score acquiring unit 134 acquires an attribute value-considering overall score corresponding to the two or more relative item scores acquired by the item score acquiring unit 133, from the correspondence table.

The output unit 14 outputs various types of information. The various types of information are, for example, the proposal information acquired by the proposal information acquiring unit 132. The output may be accumulation in a storage medium, or transmission to an external apparatus such as the terminal apparatus 2, and is a concept that encompasses display on a display screen, projection using a projector, printing by a printer, output of a sound, delivery of a processing result to another processing apparatus or another program, and the like. The output unit 14 transmits, for example, the proposal information to the terminal apparatus 2.

In the terminal storage unit 21 constituting the terminal apparatus 2, various types of information are stored. The various types of information are, for example, an organization identifier for identifying a user's organization. The various types of information are, for example, acceptance information, or the information received by the terminal receiving unit 25. The organization identifier may be regarded as information for identifying a user.

The terminal accepting unit 22 accepts various types of instructions, information, or the like. The various types of instructions, information, or the like are, for example, acceptance information, or learning instruction. The accepting is a concept that encompasses accepting information input from an input device such as a keyboard, a mouse, or a touch panel, receiving information transmitted via a wired or wireless communication line, accepting information read from a storage medium such as an optical disk, a magnetic disk, or a semiconductor memory and the like.

The various types of instructions, information, or the like may be input by any part such as a touch panel, a keyboard, a mouse, a menu screen, or the like. The terminal accepting unit 22 may be realized as a device driver for an input part such as a touch panel or a keyboard, software for controlling a menu screen, or the like.

The terminal processing unit 23 performs various types of processing. The various types of processing are, for example, a process that configures data that is to be displayed, from the information received by the terminal receiving unit 25. The various types of processing are, for example, a process that configures instructions or the like that is to be transmitted, from the instructions or the like accepted by the terminal accepting unit 22.

The terminal transmitting unit 24 transmits the various types of instructions, information, or the like to the information processing apparatus 1. The various types of instructions, information, or the like are, for example, the instructions configured by the terminal processing unit 23, or the instructions, information, or the like accepted by the terminal accepting unit 22.

The terminal receiving unit 25 receives various types of information from the information processing apparatus 1. The various types of information are, for example, proposal information.

The terminal output unit 26 acquires various types of information. The various types of information are, for example, the information accepted by the terminal accepting unit 22, the information received by the terminal receiving unit 25, or the information configured by the terminal processing unit 23. The various types of information are, for example, proposal information.

The storage unit 11, the item information storage unit 111, the organization response information storage unit 112, the organization information storage unit 113, the learning information storage unit 114, the proposal information storage unit 115, and the terminal storage unit 21 are preferably non-volatile storage media, but can also be realized by volatile storage media.

There is no limitation on the procedure in which information is stored in the storage unit 11 and the like. For example, information may be stored in the storage unit 11 and the like via a storage medium, information transmitted via a communication line or the like may be stored in the storage unit 11 and the like, or information input via an input device may be stored in the storage unit 11 and the like.

The accepting unit 12 and the terminal receiving unit 25 are typically realized by a wireless or wired communication part, but can also be realized by a broadcast receiving part.

The processing unit 13, the learning unit 131, the proposal information acquiring unit 132, the analysis part 1321, the application information acquiring part 1322, the proposal information acquiring part 1323, and the terminal processing unit 23 realized typically by MPUs, memories, or the like. Typically, the processing procedure of the processing unit 13 and the like is realized by software, and the software is stored in a storage medium such as a ROM. Note that the processing procedure may be realized also by hardware (dedicated circuits).

The output unit 14 and the terminal transmitting unit 24 are typically realized by a wireless or wired communication part, but can also be realized by a broadcasting part.

The terminal output unit 26 may be considered to include or to not include an output device such as a display screen or a speaker. The terminal output unit 26 may be realized by driver software for an output device, a combination of driver software for an output device and the output device, or the like.

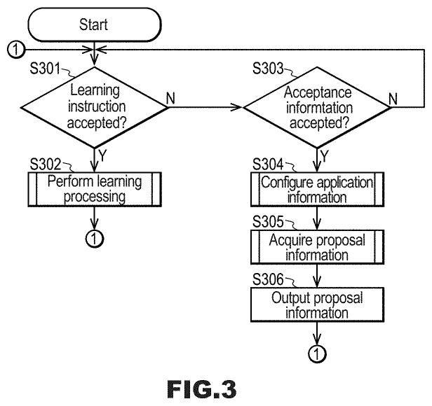

Next, an operation of the information system A will be described. First, an operation example of the information processing apparatus 1 will be described with reference to the flowchart in FIG. 3.

(Step S301) The accepting unit 12 judges whether or not it has accepted a learning instruction. If it has accepted a learning instruction, the procedure advances to step S302, and, if otherwise, the procedure advances to step S303.

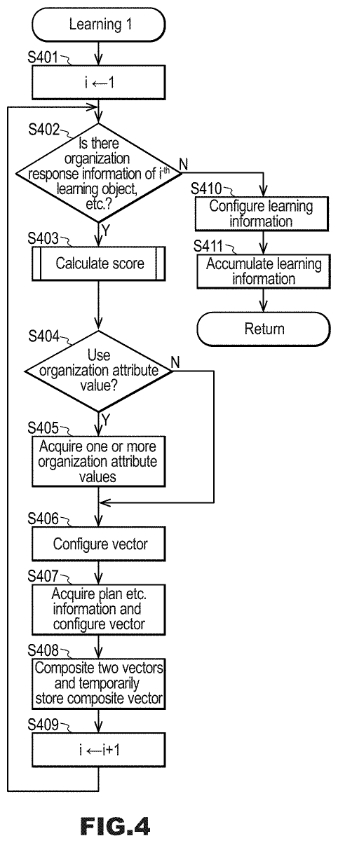

(Step S302) The learning unit 131 performs learning processing. The learning processing is a process that acquires learning information. An example of the learning processing will be described with reference to the flowcharts in FIGS. 4 to 6.

(Step S303) The accepting unit 12 judges whether or not it has accepted acceptance information. If it has accepted acceptance information, the procedure advances to step S304, and, if otherwise, the procedure returns to step S301.

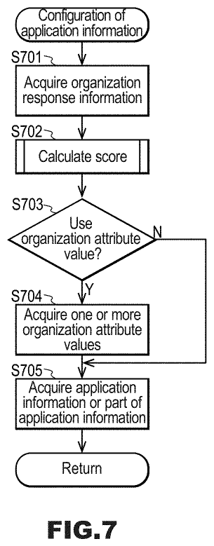

(Step S304) The proposal information acquiring unit 132 performs application information acquiring processing. The application information acquiring processing is a process that acquires application information. An example of the application information acquiring processing will be described with reference to the flowchart in FIG. 7.

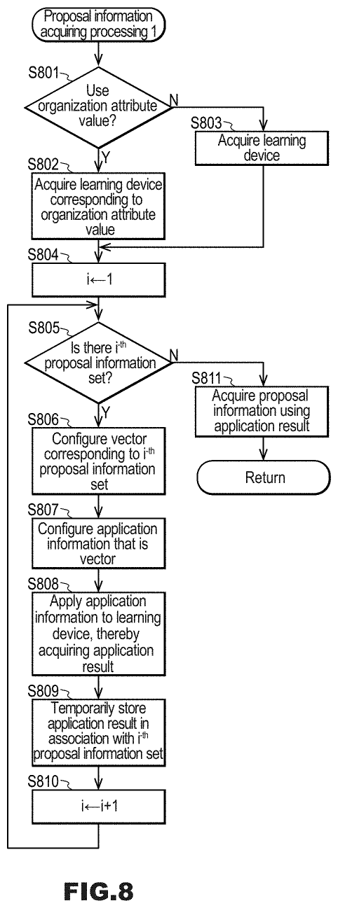

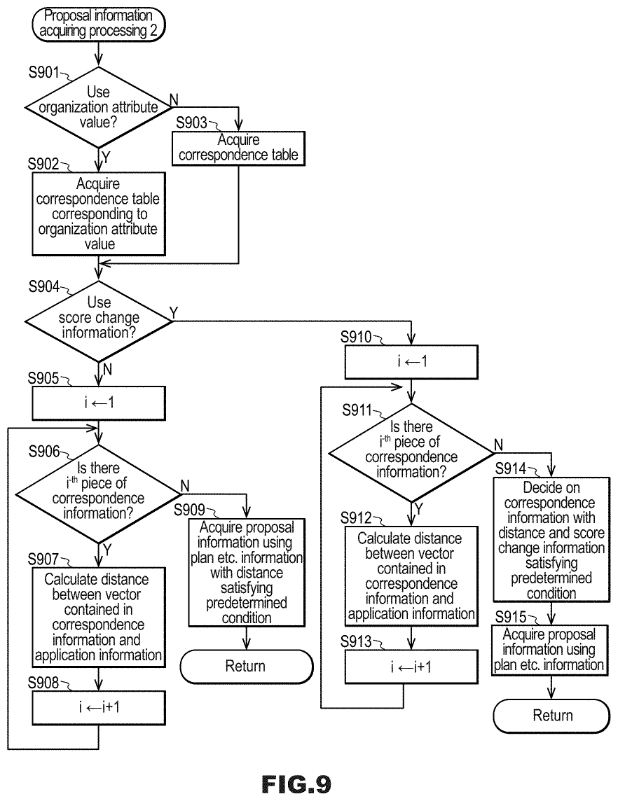

(Step S305) The proposal information acquiring unit 132 acquires proposal information using the application information acquired in step S304. An example of the proposal information acquiring processing will be described with reference to the flowcharts in FIGS. 8 and 9.

(Step S306) The output unit 14 outputs the proposal information acquired in step S305. The procedure returns to step S301.

In the flowchart shown in FIG. 3, processing ends at power off or at an interruption of ending processing.

Next, an example of the first learning processing (learning 1) in step S302 will be described with reference to the flowchart in FIG. 4. The learning 1 is an example of a process that configures learning information without using an organization attribute value.

(Step S401) The learning unit 131 substitutes 1 for a counter i.

(Step S402) The learning unit 131 judges whether or not organization response information of an i^{-th} learning object and the like are stored in the organization response information storage unit 112. If organization response information of an i^{-th} learning object and the like are stored, the procedure advances to step S403, and, if otherwise, the procedure advances to step S410. The organization response information and the like are, for example, any of (1) organization response information and positive example information (information on the performed plan, etc.) of an organization that has been improved through a plan; (2) organization response information, information on the performed plan, etc., and score change information of an organization that has been improved through a plan; and (3) organization response information and positive example information (information on the performed plan, etc.) of an organization that has been improved through a plan, and organization response information and negative example information (information on the performed plan, etc.) of an organization that has not been improved through a plan.

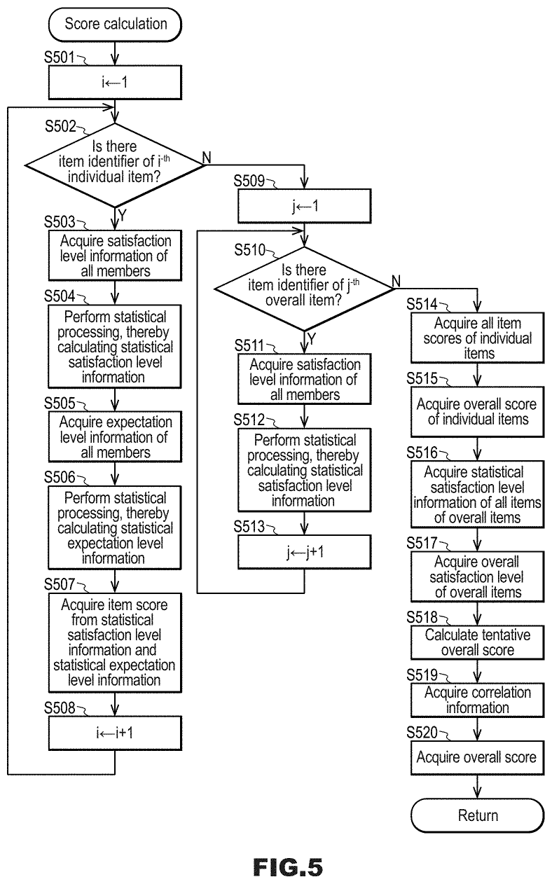

(Step S403) The learning unit 131 reads the organization response information of the i^{-th} learning object and the like from the organization response information storage unit 112. Next, the item score acquiring unit 133 and the overall score acquiring unit 134 calculates a score, using the organization response information of the i to learning object and the like. An example of the score calculating processing will be described with reference to the flowchart in FIG. 5. The score in this example is one or at least two item scores and an overall score.

(Step S404) The learning unit 131 whether or not to include information of an organization attribute value, in a vector for training. If information of an organization attribute value is to be included, the procedure advances to step S405, and, and, if otherwise, the procedure advances to step S406.

Note that it is assumed that whether or not to include information of an organization attribute value is predetermined.

(Step S405) The learning unit 131 acquires one or more organization attribute values corresponding to the organization response information of the i^{-th} learning object and the like. There is no limitation on the area in which one or more organization attribute values are stored. The learning unit 131 may for example, read one or more organization attribute values corresponding to the organization response information of the i^{-th} learning object from the organization response information storage unit 112, or may acquire an organization identifier corresponding to the organization response information of the i^{-th} learning object from the organization response information storage unit 112 and acquire one or more organization attribute values paired with the organization identifier from the organization information storage unit 113.

(Step S406) The learning unit 131 configures a vector, using the score acquired in step S403. For example, the learning unit 131 configures a vector having, as elements, item scores acquired from the organization response information. For example, the learning unit 131 configures a vector having, as elements, item scores and an overall score acquired from the organization response information. For example, the learning unit 131 configures a vector, using item scores or item scores and an overall score, and one or more organization attribute values. That is to say in this case, information acquired from one or more organization attribute values constitutes elements of the vector. For example, the vector configured from one or more organization attribute values is, for example, . . . , whether or not one or more organization attribute values contain information indicating “the industry type 1”, whether or not one or more organization attribute values contain information indicating “the industry type 2”, whether or not one or more organization attribute values contain information indicating “the industry type n”, . . ., whether or not one or more organization attribute values contain information indicating “being listed”, . . . ). For example, if one or more organization attribute values contain information indicating “the industry type 1”, the element is “1”, and, if otherwise, the element is “0”.

(Step S407) The learning unit 131 acquires plan etc. information paired with the organization response information of the i^{-th} learning object. Then, the learning unit 131 configures, for example, a vector from the plan etc. information. The vector is, for example, (whether or not the plan 1 has been implemented, whether or not the plan 2 has been implemented . . . . whether or not the plan n has been implemented), (whether or not an improvement item 1 has been used, whether or not an improvement item 2 has been used, . . . , whether or not an improvement item n has been used). The plan etc. information is, for example, plan identifying information of a plan that has been implemented, or improvement item identifying information of an improvement item that has been implemented. In this example, it is sufficient that the learning unit 131 acquires, for example, only plan etc. information.

(Step S408) The learning unit 131 composites, for example, the vector configured in step S406 and the vector acquired in step S407, and temporarily stores the composite vector in an unshown buffer. The learning unit 131 acquires, for example, correspondence information composed of a pair of the vector configured in step S406 and the plan etc, information, and temporarily stores it in an unshown buffer.

(Step S409) The learning unit 131 increments the counter i by 1. The procedure returns to step S402.

(Step S410) The learning unit 131 configures learning information, using the composite vector temporarily stored in step S408. The learning unit 131 learns, for example, two or more composite vectors through an algorithm of machine learning, thereby configuring a learning device. The learning unit 131 configures, for example, a correspondence table having pairs of two or more elements as correspondence information.

(Step S411) The learning unit 131 accumulates the learning information configured in step S410 in the learning information storage unit 114. The learning unit 131 may accumulate the learning information configured in step S410 in the learning information storage unit 114 in association with one or more organization attribute values corresponding to two or more pieces of organization response information and the like that are to be learned.

Next, an example of the score calculating processing in step S403 will be described with reference to the flowchart in FIG. 5.

(Step S501) The item score acquiring unit 133 substitutes 1 for a counter i.

(Step S502) The item score acquiring unit 133 judges whether or not there is an item identifier of an i^{-th} individual item, in the organization response information from which a score is to be calculated. If there is an item identifier of an i^{-th} individual item, the procedure advances to step S503, and, if otherwise, the procedure advances to step S509.

(Step S503) The item score acquiring unit 133 acquires satisfaction level information of all members, paired with the item identifier of the i-th individual item, in the organization response information from which a score is to be calculated.

(Step S504) The item score acquiring unit 133 performs statistical processing on the satisfaction level information acquired in step S503, thereby calculating statistical satisfaction level information. In this example, the item score acquiring unit 133 calculates, for example, statistical satisfaction level information that is an average value of the satisfaction level information acquired in step S503. Then, the item score acquiring unit 133 accumulates the calculated statistical satisfaction level information in the storage unit 11 or an unshown buffer so as to be paired. with the item identifier of the i^{-th} individual item.

(Step S505) The item score acquiring unit 133 acquires expectation level information of all members, paired with the item identifier of the i^{-th} individual item, in the organization response information from which a score is to be calculated.

(Step S506) The item score acquiring unit 133 performs statistical processing on the expectation level information acquired in step S505, thereby calculating statistical expectation level information, In this example, the item score acquiring unit 133 calculates, for example, statistical expectation level information that is an average value of the expectation level information acquired in step S503. Then, the item score acquiring unit 133 accumulates the calculated in the storage unit 11 or an unshown buffer so as to be paired with the item identifier of the i^{-th} individual item.

(Step S507) The item score acquiring unit 133 acquires an item score of the i^{-th} individual item corresponding to the organization response information, using the statistical satisfaction level information and the statistical expectation level information. The item score acquiring unit 133 applies, for example, the statistical satisfaction level information and the statistical expectation level information to the individual score table of the storage unit 11, thereby acquiring an item score of the i^{-th} individual item. Then, the item score acquiring unit 133 accumulates the acquired item score in the storage unit 11 or an unshown buffer so as to be paired with the item identifier of the i^{-th} individual item,

(Step S508) The item score acquiring unit 133 increments the counter i by 1. The procedure returns to step S502.

(Step S509) The item score acquiring unit 133 substitutes 1 for a counter j.

(Step S510) The item score acquiring unit 133 judges whether or not there is an item identifier of a j^{-th} overall item, in the organization response information from which a score is to be calculated, If there is an item identifier of a j^{-th} overall item, the procedure advances to step S511, and, if otherwise, the procedure advances to step S514.

(Step S511) The item score acquiring unit 133 acquires satisfaction level information of ail members, paired with the item identifier of the j^{-th} overall item, in the organization response information from which a score is to be calculated.

(Step S512) The item score acquiring unit 133 performs statistical processing on the satisfaction level information acquired in step S511, thereby calculating statistical satisfaction level information. In this example, the item score acquiring unit 133 calculates, for example, statistical satisfaction level information that is an average value of the satisfaction level information acquired in step S511. Then, the item score acquiring unit 133 accumulates the statistical satisfaction level information in the storage unit 11 or an unshown buffer so as to be paired with the item identifier of the j^{-th} overall item.

(Step S513) The item score acquiring unit 133 increments the counter j by 1. The procedure returns to step S510.

(Step S514) The overall score acquiring unit 134 acquires all item scores of individual items, from the storage unit 11 or the unshown buffer. The item scores of the individual items are scores acquired in step S507.

(Step S515) The overall score acquiring unit 134 acquires an overall score of the individual items, from all item scores acquired in step S514. For example, the overall score acquiring unit 134 calculates an average value of all item scores acquired in step S514, and acquires the average value as an overall score of the individual items.

(Step S516) The overall score acquiring unit 134 acquires statistical satisfaction level information of all items of the overall items, from the storage unit 11 or the unshown buffer.

(Step S517) The overall score acquiring unit 134 performs statistical processing on the satisfaction statistical level information of all items acquired in step S516, and calculates statistical satisfaction level information of the overall items. The overall score acquiring unit 134 calculates, for example, an average value of the statistical satisfaction level information of all items acquired in step S516, and acquires the average value as statistical satisfaction level information of the overall items.

(Step S518) The overall score acquiring unit 134 calculates a tentative overall score from the overall score of the individual items acquired in step S515 and the statistical satisfaction level information of the overall items acquired in step S517. The overall score acquiring unit 134 calculates a tentative overall score, for example, using the operation expression “tentative overall score=α×statistical satisfaction level information of overall items+β×overall score of individual items”. Note that α and β are parameters for weighting.

(Step S519) The overall score acquiring unit 134 acquires correlation information regarding correlation between the group of satisfaction level information and the group of expectation level information, from the group of satisfaction level information of all individual items and the group of expectation level information of all individual items.

(Step S520) The overall score acquiring unit 134 adjusts the tentative overall score acquired in step S518, using the correlation information acquired in step S519, thereby acquiring an overall score. The procedure returns to the upper-level processing. The overall score acquiring unit 134 acquires an overall score such that the higher the degree of correlation. indicated by the correlation information is, the higher the overall score is.

in the flowchart in FIG. 5, it will be appreciated that it is also possible to calculate an overall score, through another algorithm such as taking a tentative overall score as an overall score.

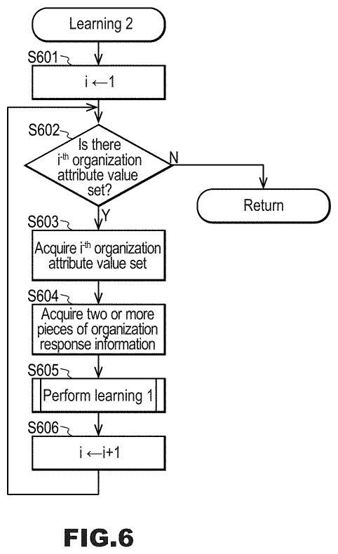

Next, an example of the second learning processing (learning 2) in step S302 will be described with reference to the flowchart in FIG. 6. The learning 2 is an example of a process that configures learning information according to an organization attribute value.

(Step S601) The learning unit 131 substitutes 1 for a counter i,

(Step S602) The learning unit 131 judges whether or not there is an i^{-th} organization attribute value set. if there is an i^{-th} organization attribute value set, the procedure advances to step S603, and, if otherwise, the procedure returns to the upper-level processing. It is assumed that learning information is configured for each of the two or more organization attribute value sets. It is assumed that each of the two or more organization attribute value sets is predetermined, and, for example, information for specifying each of the two or more organization attribute value sets is stored in the storage unit 11.

(Step S603) The learning unit 131 acquires the i^{-th} organization attribute value set from the storage unit 11.

(Step S604) The learning unit 131 acquires two or more pieces of organization response information and the like paired with the i^{-th} organization attribute value set acquired in step S603, from the organization response information storage unit 112. In this case, it is assumed that the organization response information in the organization response information storage unit 112 is associated with one or more organization attribute values.

(Step S605) The learning unit 131 performs the processing of the learning 1 described with reference to FIG. 4, on the two or more pieces of organization response information and the like acquired in step S604. For example, it is assumed that the learning information acquired as a result of the processing of the learning 1 is accumulated in the learning information storage unit 114 in association with the i^{-th} organization attribute value set.

(Step S606) The learning unit 131 increments the counter i by 1. The procedure returns to step S602.

Next, the application information acquiring processing in step S304 will be described with reference to the flowchart in FIG. 7.

(Step S701) The proposal information acquiring unit 132 acquires organization response information contained in the accepted acceptance information.

(Step S702) The item score acquiring unit 133 and the overall score acquiring unit 134 perform score calculating processing, using the organization response information acquired in step S701. The score calculating processing was described with reference to the flowchart in FIG. 5.

(Step S703) The proposal information acquiring unit 132 judges whether or not to use an organization attribute value in order to acquire application information. If an organization attribute value is to be used, the procedure advances to step S704, and, if otherwise, the procedure advances to step S705.

(Step S704) The proposal information acquiring unit 132 acquires one or more organization attribute values contained in the acceptance information.

(Step S705) The proposal information acquiring unit 132 configures a vector from the organization response information, or the organization response information and the one or more organization attribute values. The procedure returns to the upper-level processing. The vector configuring processing is similar to the processing in step S406 of FIG. 4. The configured vector is part of the application information or the application information.

Next, an example of the first proposal information acquiring processing (proposal information acquiring processing 1) in step S305 will be described with reference to the flowchart in FIG. 8. The proposal information acquiring processing 1 is an example of a process that acquires proposal information through an algorithm of machine learning.

(Step S801) The proposal information acquiring unit 132 judges whether or not to use an organization attribute value, in the proposal information acquiring processing. if an organization attribute value is to be used, the procedure advances to step S802, and, if otherwise, the procedure advances to step S803.

(Step S802) The proposal information acquiring unit 132 acquires learning device corresponding to the one or more organization attribute values contained in the accepted acceptance information, from the learning information storage unit 114. The procedure advances to step S804.

(Step S803) The proposal information acquiring unit 132 acquires a learning device from the learning information storage unit 114,

(Step S804) The proposal information acquiring unit 132 substitutes 1 for a counter i.

(Step S805) The proposal information acquiring unit 132 judges whether or not there is an i^{-th} proposal information set that may be implemented, in the storage unit 11 if there is an i^{-th} proposal information set, the procedure advances to step S806, and, if otherwise, the procedure advances to step S811.

(Step S806) The proposal information acquiring unit 132 configures a vector corresponding to the i^{-th} proposal information set, If there are three pieces of proposal information (plan A, plan B, plan C) in the proposal information storage unit 115, the i^{-th} proposal information set is any one of the seven patterns (plan A, -,-), (-, plan B, -), (-, -, plan C), (plan A, plan B, -), (plan A, -, plan C), (-, plan B, plan C), and (plan A, plan B, plan C). The vector corresponding to the i^{-th} proposal information set is any one vector of the seven patterns “(1, 0, 0), (0, 1, 0), (0, 0, 1), (1, 1, 0), (1, 0, 1), (0, 1, 1), and (1, 1, 1)”.

(Step S807) The proposal information acquiring unit 132 composites a vector composed of part of the application information configured in step S304 and the vector acquired in step S806, thereby configuring application. information that is a vector.

(Step S808) The proposal information acquiring unit 132 applies the application information configured in step 8807 to the acquired learning device, thereby acquiring an application result through an algorithm of machine learning. The application result is, for example, “positive example or negative example” or a predicted “score change information”.

(Step S809) The proposal information acquiring unit 132 temporarily stores the application result in an unshown buffer in association with the i^{-th} proposal information set.

(Step S810) The proposal information acquiring unit 132 increments the counter i by 1. The procedure returns to step S805.

(Step S811) The proposal information acquiring unit 132 selects one or more proposal information sets, using the application result, from the unshown buffer. Then, the proposal information acquiring unit 132 acquires proposal information, using the one or more proposal information sets.

For example, the proposal information acquiring unit 132 may acquire one or more proposal information sets paired with an application result indicating that it is a positive example, or may acquire one or more proposal information sets paired with “score change information” that is a value that is good enough to satisfy a predetermined condition. The predetermined condition is, for example, a condition in which the score (score change information) that is an application result is greater than or equal to a threshold or is greater than the threshold.

Next, second proposal information acquiring processing (proposal information acquiring processing 2) in step S305 will be described with reference to the flowchart in FIG. 9. The proposal information acquiring processing 2 is an example of a process that acquires proposal information using a correspondence table.

(Step S901) The proposal information acquiring unit 132 judges whether or not to use an organization attribute value, in the proposal information acquiring processing. If an organization attribute value is to be used, the procedure advances to step S902, and, if otherwise, the procedure advances to step S903.

(Step S902) The proposal information acquiring unit 132 acquires a correspondence table corresponding to the one or more organization attribute values, from the learning information storage unit 114. The procedure advances to step S904.

(Step S903) The proposal information acquiring unit 132 acquires a correspondence table, from the learning information storage unit 114.

(Step S904) The proposal information acquiring unit 132 judges whether or not to use score change information in order to acquire proposal information. If score change information is not to be used, the procedure advances to step S905, and, if otherwise, the procedure advances to step S910.

(Step S905) The proposal information acquiring unit 132 substitutes 1 for a counter i.

(Step S906) The proposal information acquiring unit 132 judges whether or not there is an i^{-th} piece of correspondence information, in the acquired correspondence table. If there is an i^{-th} piece of correspondence information, the procedure advances to step S907, and, if otherwise, the procedure advances to step S909.

(Step S907) The proposal information acquiring unit 132 calculates the distance between a vector contained in i^{-th} piece of correspondence information and the application information that is a vector, and temporarily stores the distance in association with the i^{-th} piece of correspondence information.

(Step S908) The proposal information acquiring unit 132 increments the counter i by 1. The procedure returns to step S805.

(Step S909) The proposal information acquiring unit 132 acquires plan etc. information contained in one or at least two pieces of correspondence information paired with a distance that is short enough to satisfy a predetermined condition, and configures proposal information using the plan etc. information. The procedure returns to the upper-level processing. The acquired plan etc. information may be proposal information itself.

(Step S910) The proposal information acquiring unit 132 substitutes 1 for a counter i.

(Step S911) The proposal information acquiring unit 132 judges whether or not there is an i^{-th} piece of correspondence information, in the acquired correspondence table, If there is an i^{-th} piece of correspondence information, the procedure advances to step S912, and, if otherwise, the procedure advances to step S914.

(Step S912) The proposal information acquiring unit 132 calculates the distance between a vector contained in i^{-th} piece of correspondence information and the application information that is a vector, and temporarily stores the distance in association with the i^{-th} piece of correspondence information.

(Step S913) The proposal information acquiring unit 132 increments the counter i by 1. The procedure returns to step S805.

(Step S914) The proposal information acquiring unit 132 decides on one or more pieces of correspondence information in which the distance and the score change information satisfy a predetermined condition.

(Step S915) The proposal information acquiring unit 132 acquires plan etc. information contained in each of the one or more pieces of correspondence information, and configures proposal information using the plan etc. information. The procedure returns to the upper-level processing. The acquired plan etc. information may be proposal information itself

Next, an operation of the terminal apparatus 2 will be described.

The terminal accepting unit 22 of the terminal apparatus 2 accepts various types of instructions, information, or the like. Next, the terminal processing unit 23 configures instructions or the like that is to be transmitted, from the instructions or the like accepted by the terminal accepting unit 22. The terminal transmitting unit 24 transmits the instructions or the like configured by the terminal processing unit 23, to the information processing apparatus 1. Then, in response to transmission of the instructions or the like, the terminal receiving unit 25 receives information from the information processing apparatus 1. Next, the terminal processing unit 23 configures data that is output, from the information received by the terminal receiving unit 25. Next, the terminal output unit 26 outputs the information configured by the terminal processing unit 23.

Hereinafter, a specific operation of the information system A in this embodiment will be described. FIG. 1 is a conceptual diagram of the information system A.

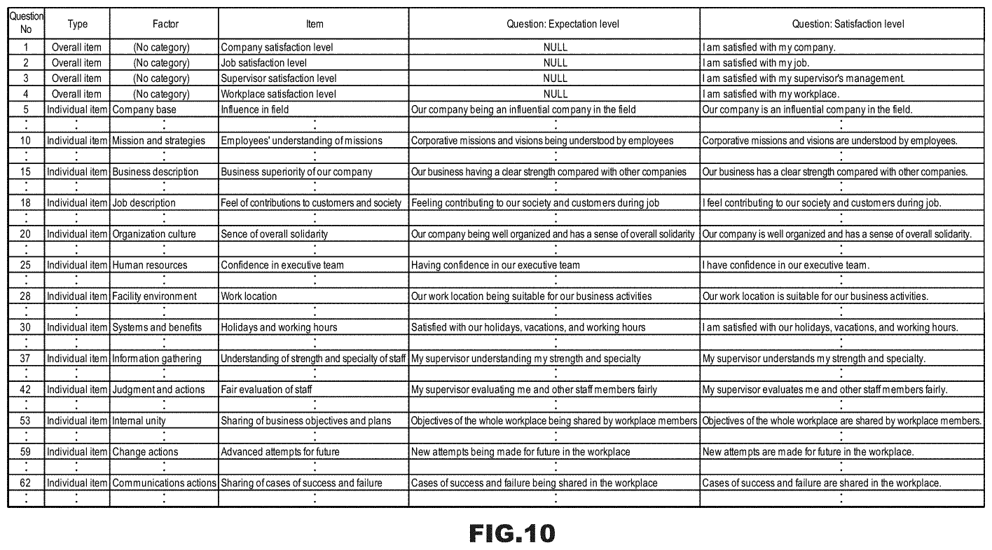

It is assumed that the item information management table shown in. FIG. 10 is stored in the item information storage unit 111. The item information management table is a table for managing a large number of pieces of item information each indicating an item of a questionnaire to a member (an employee in this example) of an organization (a company in this example). The item information in this example has “question. No”, “type”, “factor”, “item”, “question: expectation level”, and “question: satisfaction level”. “Question No” is an ID for identifying a question, and is an example of an item identifier. “Type” is information indicating the type of item, and, in this example, may be either an overall item or an individual item. “Factor” is a middle concept of an item, and may also be said to be an object. “Item” is information indicating the content of an item. “Item” may be regarded as an item identifier. “Question: expectation level” is a question for acquiring expectation level information. “Question: satisfaction level” is a question for acquiring satisfaction level information.

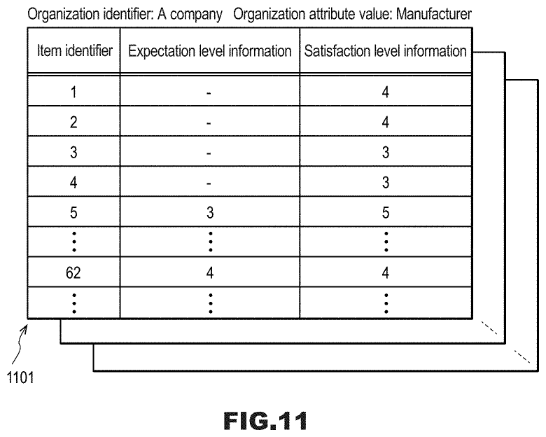

Furthermore, organization response information having, for example, a structure as shown in FIG. 11 is stored in the organization response information storage unit 112. The positive example information “plant” and “plan B” for specifying a plan or the like that has been implemented is associated with organization response information 1101. Furthermore, the improved overall score “30” (score change information=30) in the case in which the implemented “plan A” and “plan B” are successful is associated with the organization response information 1101. That is to say in the organization corresponding to the organization response information, the implemented “plan A” and “plan B” were successful, and the organization overall score was improved by an amount that was as large as 30 (score change information=30).

Two or more pieces of organization response information are stored in the organization response information storage unit 112. It is assumed that the positive example information and the score change information are associated with each piece of the organization response information.

FIG. 11 shows organization response information of an organization identified with the organization identifier “A company”. 1101 denotes member response information of one employee of the organization identified with the organization identifier “A company”. The organization response information of an organization identified. with the organization identifier “A company” contains member response information of two or more employees. The member response information has a large number of (63 or more in this example) records each having “item identifier”, “expectation level information”, and “satisfaction level information”. The record of an item with an item identifier of 1 to 4 is a record of an overall item, and has no expectation level information. Then, the expectation level information and the satisfaction level information constituting the member response information of 1101 are information acquired from responses of an employee to “question: expectation level” and “question: satisfaction level” of the item information management table shown in FIG. 10. This responses in this example are responses indicated by a natural number of 1 to 5. In this example, if the expectation level information to “question: expectation level” is 1, the expectation level is lowest, and, if the expectation level information is 5, the expectation level is highest. If the satisfaction level information to “Question: satisfaction level” is 1, the satisfaction level is lowest, and, if the satisfaction level information is 5, the satisfaction level is highest. Furthermore, it is assumed that the organization attribute value indicating the industry type of the organization identified with the organization identifier “A company” is “manufacturer”. The industry type is an example of the organization attribute. It is assumed that multiple pieces of organization response information of organizations corresponding to the organization attribute value “manufacturer” are stored in the organization response information storage unit 112.

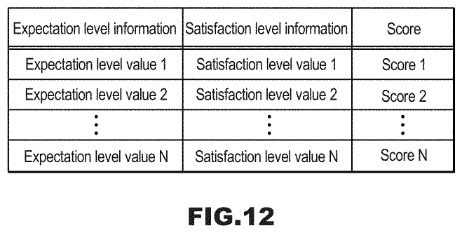

Furthermore, the individual score table shown in FIG. 12 is stored in the storage unit 11. In the individual score table, two or more records each having “expectation level information”, “satisfaction level information”, and “score” are managed. “Expectation level information” is, for example, an average value of the expectation level information. “Expectation level information” may be, for example, information indicating the range of an average value of the expectation level information, “Expectation level value 1”, “expectation level value 2” and “expectation level value N”, which are attribute values of “expectation level information”, are information indicating specific values or ranges. “Satisfaction level information” is, for example, an average value of the satisfaction level information. “Satisfaction level information” may be, for example, information indicating the range of an average value of the satisfaction level information. “Satisfaction. level value 1”, “satisfaction level value 2” and “satisfaction level value N”, which are attribute values of “satisfaction level information”, are information indicating specific values or ranges. “Score” in this example is information indicating an item score. “Score 1”, “score 2” . . . , and “score N”, which are attribute values of “score”, are specific values.

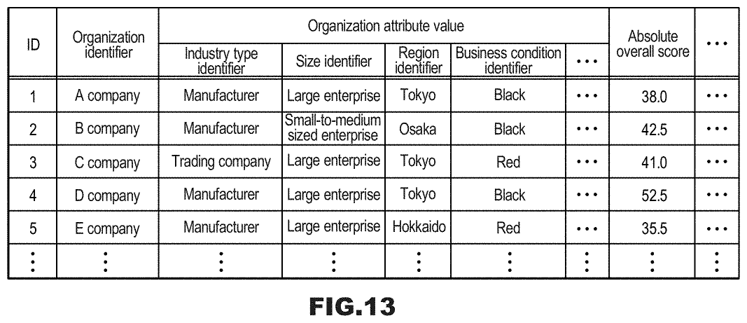

Furthermore, the organization information management table shown in FIG. 13 is stored in the organization information storage unit 113. The organization information management table is a table for managing organization information. The organization information management table has two or more records each having “ID”, “Organization identifier”, “Organization attribute value”, “Absolute overall score”, and the like. “Organization attribute value” in this example has “industry type identifier”, “size identifier”, “region identifier”, “business conditions identifier”, and the like. “Industry type identifier” is information for identifying an industry type, in this example, such as manufacturer, trading company bank, or the like. “Size identifier” is information for identifying a size of an organization, such as large enterprise, small-to-medium sized enterprise, micro enterprise, self-employed, or the like. “Region identifier” is information for identifying a location of a home office of an organization (company, etc.), such as any one of the prefectures. “Business conditions identifier” is information for identifying a business condition, such as being the black or the red, or the like. “Absolute overall score” is an overall score before implementation of a plan (before an improvement).

Moreover, it is assumed that proposal information for specifying three plans (plan A, plan B, plan C) is stored in the proposal information storage unit 115.

Hereinafter, the following two specific examples in this situation will be described. Specific Example 1 is a case using a learning device. Specific Example 2 is a case using a correspondence table.

### SPECIFIC EXAMPLE 1

In Specific Example 1, it is assumed that a learning device configured by the learning unit 131 is stored in the learning information storage unit 114. That is to say, in this example, it is assumed that, for example, the learning unit 131 acquires a learning device through an algorithm of machine learning, using a large number of piece of information having the organization response information, the positive example information, and the score change information stored in the organization response information storage unit 112, and accumulates the learning device in the learning information storage unit 114. It is assumed that this learning device is, for example, a learning device acquired by applying a large number of vectors constituted by information having the organization response information, the positive example information, and the score change information, to an algorithm of machine learning. Furthermore, the vectors applied to the algorithm of machine learning have, for example, the structure (the item score of the item 1, the item score of the item 2, . . . , the item score of the item n, whether or not one or more organization attribute values contain information indicating “the industry type 1”, whether or not one or more organization attribute values contain information indicating “the industry type 2”, whether or not one or more organization attribute values contain information indicating “the industry type n”, whether or not one or more organization attribute values contain information indicating “being listed”, . . . , whether or not the plan A has been implemented, whether or not the plan B has been implemented, whether or not the plan C has been implemented, score change information). The algorithm of machine learning is, for example, SVR.

In this situation, it is assumed that the accepting unit 12 accepts acceptance information containing organization response information.

Next, the proposal information acquiring unit 132 acquires organization response information contained in the accepted acceptance information.

Next, the item score acquiring unit 133 and the overall score acquiring unit 134 perform the above-described score calculating processing, using the acquired organization response information. Then, it is assumed that item scores and an overall score (e.g., “41”) are acquired,

Next, the proposal information acquiring unit 132 configures a vector having the structure (the item score of the item 1, the item score of the item 2, . . . , the item score of the item n), from the item scores.

Next, the proposal information acquiring unit 132 acquires seven proposal information sets that may be implemented. The seven proposal information sets are (plan A, -,-), (-, plan B, -), (-, -, plan C), (plan A, plan B, -), (plan A, -, plan C), (-, plan B, plan C), and (plan A, plan B, plan C). The proposal information acquiring unit 132 acquires vectors “(1, 0, 0), (0, 1, 0), (0, 0, 1), (1, 1, 0), (1, 0, 1), (0, 1, 1), (1, 1, 1)” from the proposal information sets.

Next, the proposal information acquiring unit 132 composites the vector having the structure (the item score of the item 1, the item score of the item 2, the item score of the item n) and the vector configured from the seven proposal information sets, thereby acquiring seven composite vectors,

Next, the proposal information acquiring unit 132 sequentially applies the seven composite vectors to the learning device, thereby acquiring scores through an algorithm of machine learning (e.g., SVR). The scores in this example are score change information. That is to say, the proposal information acquiring unit 132 acquires seven scores.

Next, the proposal information acquiring unit 132 acquires a vector (e.g., “(1, 0, 1)”) corresponding the largest score (e.g., 35). Next, the proposal information acquiring unit 132 acquires a proposal information set (plan A, plan C) corresponding to the acquired vector.

Next, the proposal information acquiring unit 132 acquires an overall score “41”, score change information “35”, and plan etc. information “plan A, plan C” that constitute proposal information that is output in this example. Next, the proposal information acquiring unit 132 configures proposal information “Your current overall score is “41”. With implementation of “Plan A, Plan C”, the overall score will be “76”.”, using the acquired information.

Next, the output unit 14 accumulates the acquired proposal information in the storage unit 11 in association with an organization identifier (e.g., “C01”) corresponding to the accepted organization response information.

Furthermore, it is assumed that an output instruction having the organization identifier (e.g., “C01”) is input to the terminal apparatus 2. Then, the terminal accepting unit 22 of the terminal apparatus 2 accepts the output instruction. The terminal processing unit 23 configures an output instruction (having “C01”) that is transmitted, from the output instruction accepted by the terminal accepting unit 22. The terminal transmitting unit 24 transmits the instructions or the like configured by the terminal processing unit 23, to the information processing apparatus 1.

Next, the accepting unit 12 of the information processing apparatus 1 receives the output instruction (having “C01”), Next, the processing unit 13 reads the proposal information “current overall score “41”, “With implementation of “Plan A, Plan C”, the overall score will be “76”,” paired with the organization identifier “C01”, from the storage unit 11. Then, the output unit 14 transmits the proposal information “current overall score “41”, “With implementation of “Plan A, Plan C”, the overall score will be “76”.”, to the terminal apparatus 2.

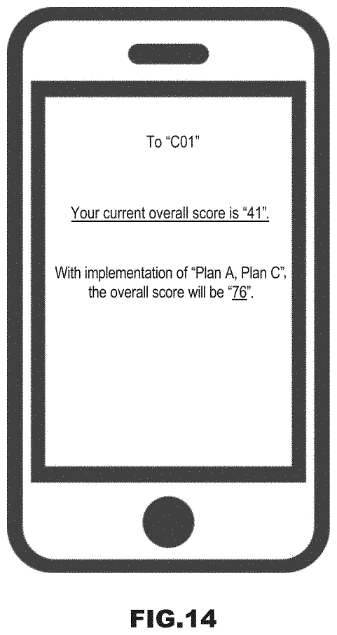

Next, in response to transmission of the output instruction, the terminal receiving unit 25 of the terminal apparatus 2 receives the proposal information from the information processing apparatus 1. Next, the terminal processing unit 23 configures data that is output, from the proposal information received by the terminal receiving unit 25. Next, the terminal output unit 26 outputs the proposal information configured by the terminal processing unit 23. FIG. 14 shows an example of the output.

### SPECIFIC EXAMPLE 2

In Specific Example 2, it is assumed that a correspondence table configured by the learning unit 131 is stored in the learning information storage unit 114. The correspondence table has “ID” and “correspondence information”. “Correspondence information” has “vector” and “positive example information”. The structure of “vector” is, for example, (the item score of the item 1, the item score of the item 2, . . . , the item score of the item n, whether or riot one or more organization attribute values contain information indicating “the industry type 1”, whether or not one or more organization attribute values contain information indicating “the industry type 2”, . . . , whether or not one or more organization attribute values contain information indicating “the industry type n”, . . . , whether or not one or more organization attribute values contain information indicating “being listed”, . . . ). That is to say the learning unit 131 configures a vector, using the above-described method, from organization response information before a plan is implemented, and one or more organization attribute values. The learning unit 131 acquires positive example information for specifying implemented one or more plans, in the case in which an organization has been improved through implementation of the plan (e.g., the overall score has increased by an amount that is greater than or equal to a threshold), from the organization response information storage unit 112. Then, the learning unit 131 configures correspondence information having the configured vector and the positive example information, for each piece of the organization response information in the organization response information storage unit 112, and adds the information to the correspondence table. Through this processing, the correspondence table of the learning information storage unit 114. In this example, the positive example information is a group of one or more pieces of plan identifying information.

In this situation, it is assumed that the accepting unit 12 accepts acceptance information containing organization response information.

Next, the proposal information acquiring unit 132 acquires organization response information contained in the accepted acceptance information.

Next, the item score acquiring unit 133 and the overall score acquiring unit 134 perform the above-described score calculating processing, using the acquired organization response information. Then, it is assumed that item scores and an overall score (e.g., “41”) are acquired,

Next, the proposal information acquiring unit 132 configures a vector having the structure (the item score of the item 1, the item score of the item 2, . . . , the item score of the item n), from the item scores.

Next, the proposal information acquiring unit 132 configures a vector (application information), using the vector having the structure (the item score of the item 1, the item score of the item 2, . . . , the item score of the item n) and the one or more organization attribute values. The structure of the vector is (the item score of the item 1, the item score of the item 2, . . . , the item score of the item n, whether or not one or more organization attribute values contain information indicating “the industry type 1”, whether or not one or more organization attribute values contain information indicating “the industry type 2”, . . . , whether or not one or more organization attribute values contain information indicating “the industry type n”, . . . , whether or not one or more organization attribute values contain information indicating “being listed”, . . . ).

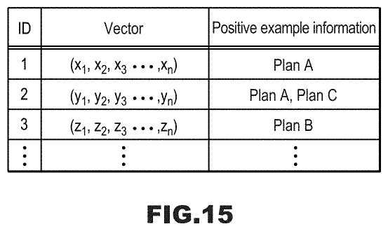

Next, the proposal information acquiring unit 132 calculates the distance between the configured application information and the vector of each piece of the correspondence information in FIG. 15. Then, it is assumed that the proposal information acquiring unit 132 acquires positive example information (e.g., “plan A, plan C”) paired with a vector with the shortest distance.

Next, the proposal i formation acquiring unit 132 acquires an overall score “41”, score change information “35”, and plan etc. information “plan A, plan C” that constitute proposal information that is output in this example. Next, the proposal information acquiring unit 132 configures proposal information “current overall score “41”, “With implementation of “Plan A, Plan C”, the overall score will be “76”.”, using the acquired information.

Next, the output unit 14 accumulates the acquired proposal information in the storage unit 11 in association with an organization identifier (e.g., “C01” corresponding to the accepted organization response information.

Furthermore, it is assumed that an output instruction having the organization identifier (e.g., “C01”) is input to the terminal apparatus 2. Then, the terminal accepting unit 22 of the terminal apparatus 2 accepts the output instruction. The terminal processing unit 23 configures an output instruction (having “C01”) that is transmitted, from the output instruction accepted by the terminal accepting unit 22. The terminal transmitting unit 24 transmits the instructions or the like configured by the terminal processing unit 23, to the information processing apparatus 1.

Next, the accepting unit 12 of the information processing apparatus 1 receives the output instruction (having “C01”). Next, the processing unit 13 reads the proposal information “current overall score “41”, “With implementation of “Plan A, Plan C”, the overall score will be “76”.” paired with the organization identifier “C01”, from the storage unit 11. Then, the output unit 14 transmits the proposal information “current overall score “41”,

“With implementation of “Plan A, Plan C”, the overall score will be “76”.”, to the terminal apparatus 2.

Next, in response to transmission of the output instruction, the terminal receiving unit 25 of the terminal apparatus 2 receives the proposal information from the information processing apparatus 1. Next, the terminal processing unit 23 configures data that is output, from the proposal information received by the terminal receiving unit 25. Next, the terminal output unit 26 outputs the proposal information configured by the terminal processing unit 23. FIG. 14 shows an example of the output.

As described above, according to this embodiment, it is possible to make a proper proposal for improving an organization, using the organization response information.

Furthermore, according to this embodiment, it is possible to make a more proper proposal for improving an organization, according to the organization attribute value, using the organization response information,

Furthermore, according to this embodiment, it is possible to make a more proper proposal for improving an organization, also using a natural language sentence described by a member.

Moreover, according to this embodiment, it is possible to make a more proper proposal for improving an organization, using the organization response information and the score change information of an organization.

The processing in this embodiment may be realized by software. The software may be distributed by software downloads or the like. Furthermore, the software may be distributed in a form where the software is stored in a storage medium such as a CD-ROM, Note that the same is applied to other embodiments described in this specification. The software that realizes the information processing apparatus 1 in this embodiment is the following sort of program. Specifically this program is, for example, a program for causing a computer capable of accessing an organization response information storage unit in which two or more pieces of organization response information each indicating a response to a question to an organization member are stored in association with organization identifiers each for identifying an organization, and a learning information storage unit in which learning information acquired using two or more pieces of positive example information regarding one or more improvement items or one or more plans in a case in which each of the two or more organizations is improved is stored, to function as: an accepting unit that accepts acceptance information containing organization response information indicating a response to a question to an organization member; a proposal information acquiring unit that acquires proposal information, which is information corresponding to the acceptance information and is information regarding one or more improvement items or one or more plans, using the learning information; and an output unit that outputs the proposal information.

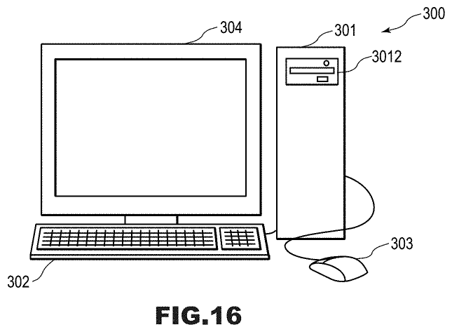

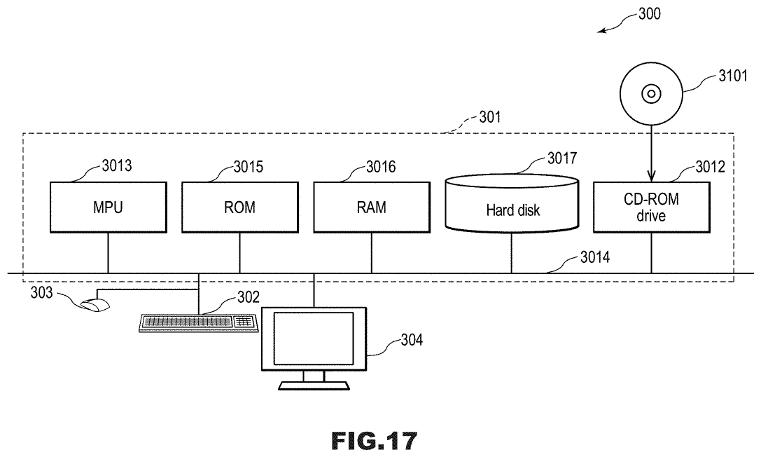

FIG. 16 shows the external appearance of a computer that executes the program described in this specification to realize the information processing apparatus 1 and the like in the foregoing various embodiments. The foregoing embodiments may be realized using computer hardware and a computer program executed thereon. FIG. 16 is a schematic view of a computer system 300. FIG. 17 is a block diagram of the system 300. FIGS. 16 and 17 show the external appearance and the like of a computer that realizes the engagement system.

In FIG. 16, the computer system 300 includes a computer 301 including a CD-ROM drive 3012, a keyboard 302, a mouse 303, and a monitor 304.

In FIG. 17, the computer 301 includes, in addition to the CD-ROM drive 3012, an MPU 3013, a bus 3014 connected to the CD-ROM drive 3012 and the like, a ROM 3015 in which a program such as a boot up program is stored, a RAM 13016 that is connected to the MPU 3013 and is a memory in which a command of an application program is temporarily stored and a temporary storage area is provided, and a hard disk 3017 in which an application program, a system program, and data are stored. Although not shown, the computer 301 may further include a network card that provides connection to a LAN.

The program for causing the computer system 300 to execute the functions of the information processing apparatus 1 and the like in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017, At the time of execution, the program is loaded into the RAM 3016. The program may be loaded from the CD-ROM 3101, or directly from a network.

The program does not necessarily have to include, for example, an operating system (OS) or a third party program to cause the computer 301 to execute the functions of the information processing apparatus 1 and the like in the foregoing embodiments. The program may only include a command portion to call an appropriate function (module) in a controlled mode and obtain desired results. The manner in which the computer system 300 operates is well known, and thus a detailed description thereof has been omitted.

It should be noted that, in the program, in a step of transmitting information, a step of receiving information, or the like, processing that is performed by hardware, for example, processing performed by a modem or an interface card in the transmitting step (processing that can be performed only by hardware) is not included.

Furthermore, the computer that executes the program may be a single computer, or may be multiple computers. That is to say centralized. processing may be performed, or distributed processing may be performed.

Furthermore, in the foregoing embodiments, it will be appreciated that two or more communication parts in one apparatus may be physically realized by one medium.

In the foregoing embodiments, each process may be realized as centralized processing using a single apparatus, or may be realized as distributed processing using multiple apparatuses. That is to say the information processing apparatus 1 may be a stand-alone apparatus. If the information processing apparatus 1 is a stand-alone apparatus, the accepting unit 12 accepts instructions, information, or the like from users or the like. The output unit 14 outputs information and the like through displaying, sound output, or transmission to a display apparatus.

The present invention is not limited to the embodiment set forth herein. Various modifications are possible within the scope of the present invention.

As described above, the information processing apparatus according to the present invention has the effect of making it possible to make a proper proposal for improving an organization, using the organization response information, and thus this apparatus is useful as an information processing apparatus and the like.

What is claimed is:

1. An information processing apparatus comprising:
an organization response information storage unit in which two or more pieces of organization response information each indicating a response to a question to an organization member are stored in association with organization identifiers each for identifying an organization;
a learning information storage unit in which learning information acquired using two or more pieces of positive example information regarding one or more improvement items or one or more plans in a case in which each of the two or more organizations is improved is stored;
an accepting unit that accepts acceptance information containing organization response information indicating a response to a question to an organization member;
a proposal information acquiring unit that acquires proposal information, which is information corresponding to the acceptance information and is information regarding one or more improvement items or one or more plans, using the learning information; and
an output unit that outputs the proposal information.

2. The information processing apparatus according to claim 1,
wherein the positive example information contains one or more organization attribute values, each of which is an attribute value of an organization,
the accepting unit accepts acceptance information having organization response information and one or more organization attribute values, and
the proposal information acquiring unit acquires proposal information, which is information corresponding to the acceptance information having the organization response information and the one or more organization attribute values accepted by the accepting unit and is information regarding one or more improvement items or one or more plans, using the learning information.

3. The information processing apparatus according to claim 2,
wherein, in the learning information storage unit, two or more pieces of learning information associated with one or more organization attribute values are stored, and
the proposal information acquiring unit acquires proposal information, using learning information corresponding to the one or more organization attribute values contained in the acceptance information.

4. The information processing apparatus according to claim 1, wherein the organization response information contains a natural language sentence,
the positive example information also contains an analysis result acquired by analyzing the natural language sentence contained in the organization response information, and
the proposal information acquiring unit includes:
an analysis part that analyzes the natural language sentence contained in the organization response information accepted by the accepting unit, thereby acquiring an analysis result;
an application information acquiring part that acquires application information that is applied to learning information, using information that is contained in the organization response information and is other than the natural language sentence, and the analysis result; and
a proposal information acquiring part that applies the application information to the learning information, thereby acquiring proposal information.

5. The information processing apparatus according to claim 1,
wherein score change information regarding a change in a score of an organization is stored in association with the positive example information, and
the proposal information acquiring unit acquires proposal information, which is information corresponding to the acceptance information and is information regarding one or more improvement items or one or more plans, also using the score change information.

6. The information processing apparatus according to claim 1,
wherein the learning information is a learning device trained through an algorithm of machine learning, using organization response information and positive example information, and
the proposal information acquiring unit includes:
an application information acquiring part that acquires application information that is a vector, using the acceptance information accepted by the accepting unit; and
a proposal information acquiring part that applies the application information to the learning information, thereby acquiring proposal information through an algorithm of machine learning.

7. The information processing apparatus according to claim 1,
wherein the learning information is a correspondence table containing two or more pieces of correspondence information having a vector configured using organization response information and one or more pieces of positive example information in association with each other, and
the proposal information acquiring unit includes:
an application information acquiring part that acquires application information that is a vector, using the acceptance information accepted by the accepting unit; and
a proposal information acquiring part that acquires one or more pieces of proposal information paired with a vector satisfying a condition that is predetermined for the application information, from the correspondence table.

8. An information processing method realized by an organization response information storage unit in which two or more pieces of organization response information each indicating a response to a question to an organization member are stored in association with organization identifiers each for identifying an organization, a learning information storage unit in. which learning information acquired using two or more pieces of positive example information regarding one or more improvement items or one or more plans in a case in which each of the two or more organizations is improved is stored, an accepting unit, a proposal information acquiring unit, and an output unit, comprising:
an accepting step of the accepting unit accepting acceptance information containing organization response information indicating a response to a question to an organization member;
a proposal information acquiring step of the proposal information acquiring unit acquiring proposal information, which is information corresponding to the acceptance information and is information regarding one or more improvement items or one or more plans, using the learning information; and
an output step of the output unit outputting the proposal information.

9. A storage medium on which a program is stored, the program causing a computer capable of accessing an organization response information storage unit in which two or more pieces of organization response information each indicating a response to a question to an organization member are stored in association with organization identifiers each for identifying an organization, and a learning information storage unit in which learning information acquired using two or more pieces of positive example information regarding one or more improvement items or one or more plans in a case in which each of the two or more organizations is improved is stored, to function as:
an accepting unit that accepts acceptance information containing organization response information indicating a response to a question to an organization member;
a proposal information acquiring unit that acquires proposal. information, which is information corresponding to the acceptance information and is information regarding one or more improvement items or one or more plans, using the learning information; and
an output unit that outputs the proposal information.
